(19) United States
(12) Patent Application Publication
(10) Pub. No.: US 2014/0330591 A1
(43) Pub. Date: Nov. 6, 2014

(54) Calculation of Premium Amounts for the Generation of an Annuity Based on a Pension Plan

(71) Applicant: Dylan J. Tyson, Short Hills, NJ (US)

(72) Inventor: Dylan J. Tyson, Short Hills, NJ (US)

(21) Appl. No.: 13/875,956

(22) Filed: May 2, 2013

(51) Int. Cl. G06Q 40/00

(52) U.S. Cl. CPC G06Q 40/08
USPC 705/4

(57) ABSTRACT

According to one embodiment, a system includes one or more processors operable to, for each of the plurality of participants of a pension plan, determine data indicative of a first premium amount associated with a benefit of the pension plan that the participant is not eligible to elect to receive as a liability payout, and determine data indicative of a second premium amount associated with a benefit of the pension plan that the participant is eligible to elect to receive as the liability payout. The processors are further operable to determine a first total premium amount associated with a generation of an annuity based on the pension plan, and communicate the first total premium amount for display. The processors are further operable to determine a second total premium amount associated with the generation of the annuity, and communicate the second total premium amount for display.

### TECHNICAL FIELD

This disclosure relates generally to retirement plans and more particularly to a calculation of premium amounts for the generation of an annuity based on a pension plan.

### BACKGROUND

An organization may typically sponsor a pension plan for employees of the organization. This pension plan may be liable to pay the benefits associated with the pension plan. For example, when an employee retires, the pension plan may pay the employee a monthly income amount for the remainder of the employee's life. However, if the pension plan is unable to pay benefits (e.g., due to a deficiency in pension funds), the organization (as sponsor of the pension plan) may be obligated to pay for the deficiencies. As a result, the organization may be forced to spend a considerable amount of time focusing on its pension obligations instead of spending time focusing on its core business.

### SUMMARY

According to one embodiment, a system includes a memory and one or more processors communicatively coupled to the memory. The processors are operable to receive data indicative of a plurality of participants in a pension plan. The processors are further operable to, prior to any of the plurality of participants electing to receive a liability payout associated with the pension plan, and for each of the plurality of participants, determine data indicative of a first premium amount associated with a benefit of the pension plan that the participant is not eligible to elect to receive as the liability payout, and determine data indicative of a second premium amount associated with a benefit of the pension plan that the participant is eligible to elect to receive as the liability payout. The processors are further operable to determine a first total premium amount associated with a generation of an annuity based on the pension plan, the first total premium amount being based, at least in part, on the first premium amount for each of the plurality of participants and the second premium amount for each of the plurality of participants. The processors are further operable to communicate the first total premium amount for display. The processors are further operable to receive data indicative of a determination that a subset of the plurality of participants elected to not receive the liability payout. The processors are further operable to determine a second total premium amount associated with the generation of the annuity based on the pension plan, the second total premium amount being based, at least in part, on the first premium amount for each of the plurality of participants and the second premium amount for each of the subset of the plurality of participants. The processors are further operable to communicate the second total premium amount for display.

Certain embodiments may provide various technical advantages. For example, by determining the first total premium amount prior to any of the plurality of participants electing to receive a liability payout, a pension plan (and/or an organization sponsoring the pension plan) may be able to understand how the cost of the generation of the annuity will be determined, even though one or more of the variables associated with that generation may still be unknown. As such, the pension plan (and/or the organization sponsoring the pension plan) may be able to enter into an agreement regarding the generation of the annuity based on the pension plan and still understand how the cost will be determined when the generation of the annuity actually occurs.

Other technical advantages will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and various advantages, reference is now made to the following description, taken in conjunction with the accompanying drawings, in which:

FIG. 1A illustrates an example transaction that includes a generation of an annuity based on a pension plan according to one embodiment of the present disclosure;

FIG. 1B illustrates an example timeline for a generation of an annuity based on a pension plan according to one embodiment of the present disclosure;

FIG. 2 illustrates a system for providing calculations and/or adjustments associated with premium amounts for a generation of an annuity based on a pension plan according to one embodiment of the present disclosure;

FIG. 3 illustrates a method for calculating premium amounts associated with a generation of an annuity based on a pension plan according to one embodiment of the present disclosure;

FIG. 4 illustrates a method for adjusting premium amounts associated with a generation of an annuity based on a pension plan according to one embodiment of the present disclosure;

FIG. 5 illustrates a method for adjusting premium amounts associated with a generation of an annuity based on a pension plan using one or more characteristics of the assets received according to one embodiment of the present disclosure; and

FIG. 6 illustrates a method for calculating an amount of a premium amount for allocation to a general account, and for further calculating an amount of the premium amount for allocation to a separate account according to one embodiment of the present disclosure.

### DETAILED DESCRIPTION OF THE EXAMPLE EMBODIMENTS

It should be understood at the outset that although example implementations of embodiments of the disclosure are illustrated below, the present disclosure may be implemented using any number of techniques, whether currently known or not. The disclosure should in no way be limited to the example implementations, drawings, and techniques illustrated below. Additionally, the drawings are not necessarily drawn to scale.

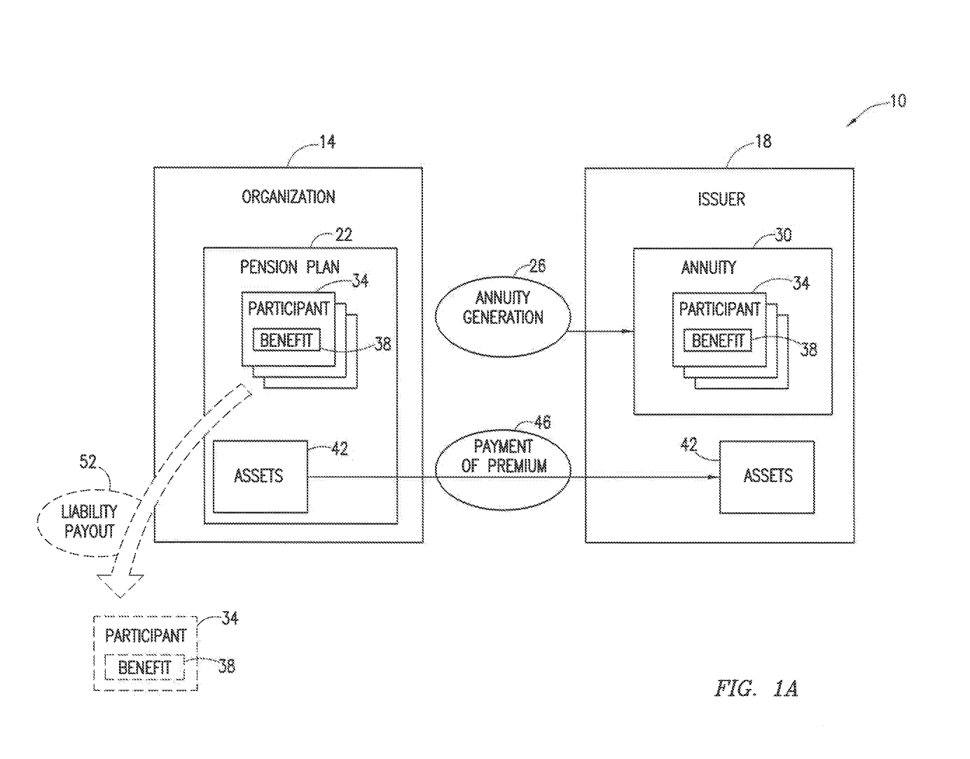

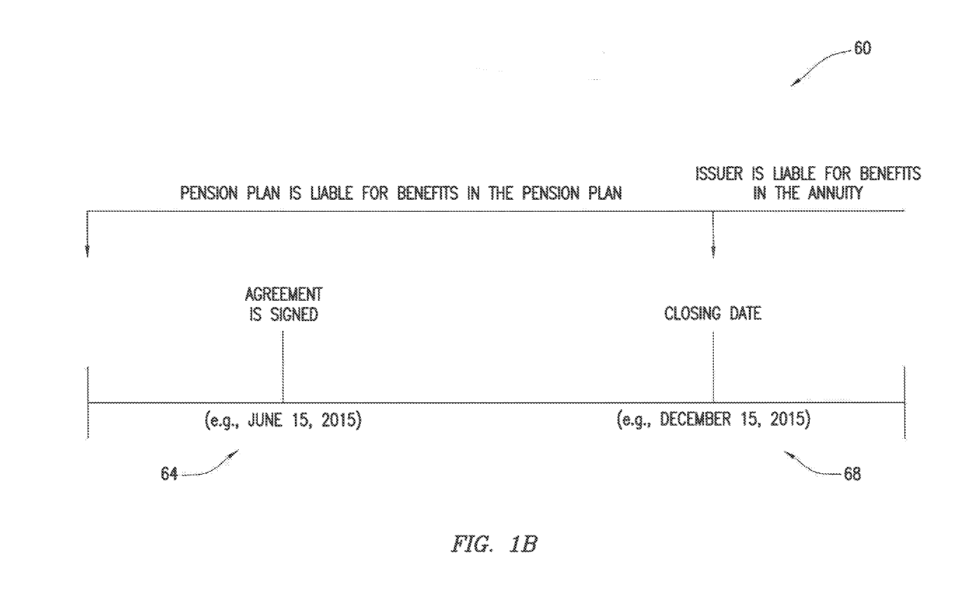

FIG. 1A illustrates an example transaction 10 that includes a generation of an annuity based on a pension plan according to one embodiment of the present disclosure. In the embodiment shown in FIG. 1A, pension plan 22 (and/or organization 14) and issuer 18 may utilize annuity generation 26 to transfer risk associated with one or more benefits 38 from the pension plan 22 to the issuer 18.

Organization 14 may represent an entity that sponsors a pension plan. For example, organization 14 may be a corporation, company, store, merchant, government, or any other entity that sponsors a pension plan. By sponsoring a pension plan (such as pension plan 22, disclosed in detail below), organization 14 may be obligated to pay for one or more deficiencies in the pension plan (e.g., the inability to pay for benefits associated with the pension plan).

Issuer 18 may represent an entity that generates (or otherwise provides) an annuity. For example, issuer 18 may be a bank, an insurance company, a mutual fund company, or any other business entity engaged in the sale, issuance, and/or management of one or more annuities. Issuer 18 may also represent multiple entities that operate together to provide an annuity. By providing an annuity (such as annuity 30, disclosed in detail below), issuer 18 may be liable for one or more benefits associated with the annuity.

Pension plan 22 may represent any suitable arrangement to provide eligible participants with an income amount. Pension plan 22 may be any suitable pension plan. For example, pension plan 22 may be a public pension plan (such as a pension plan for public school employees), a private pension plan (such as a pension plan provided by a private company or by a private employer), a government pension plan (such as a pension provided by a state, county, or municipal government entity), any other suitable pension plan, or any combination of the preceding. Pension plan 22 may be a defined benefit plan, such that an amount of money received by an eligible participant upon retirement is determined by a set formula, rather than depending upon investment returns. Pension plan 22 may include a general fund that is used to pay out benefits of pension plan 22. Pension plan 22 may include a general fund or trust that is used to manage assets (such as assets 42, disclosed below) for the sole purpose of paying out benefits of pension plan 22 to eligible participants of pension plan 22.

Pension plan 22 may provide eligible participants with an income amount when they are no longer earning a regular income from employment. For example, the eligible participants may receive the income amount when they have retired from their employment, and may continue to receive the income amount until they die, their benefits from pension plan 22 expire, or any other suitable time period. As another example, the eligible participants may receive an income amount when they are no longer employed for reasons other than retirement, such as disability, unintentional unemployment, or any other suitable reason. In order to receive an income amount from pension plan 22, eligible participants may provide a percentage of their salary to pension plan 22. On the other hand, the eligible participants may not provide any money to pension plan 22 (such as when pension plan 22 is funded entirely by an employer, the government, or any other suitable entity).

Pension plan 22 may have one or more administrators, boards, or committees that may oversee pension plan 22, have the authority to sign documents related to pension plan 22, and/or have a fiduciary duty to meet obligations of pension plan 22. The transfer of risk from the pension plan 22 to the issuer 18 may be based on an agreement (or any other contract) signed by the one or more administrators, boards, and/or committees of pension plan 22.

Pension plan 22 may include participants 34 and benefits 38. Participant 34 may represent an eligible member in pension plan 22 that may be provided with an income amount as a result of participation in pension plan 22. Participant 34 may have any suitable relationship with organization 14. For example, participant 34 may be a current employee of organization 14 or an ex-employee of organization 14. Pension plan 22 may include any suitable number of participants 34. For example, pension plan 22 may include two participants 34, 100 participants 34, 1,000 participants 34, 10,000 participants 34, 100,000 participants 34, 1 million participants 34, or any other suitable number of participants 34.

Benefit 38 may represent an income amount associated with a particular participant 34 in pension plan 22. For example, benefit 38 may be an income amount that pension plan 22 is liable to pay to the participant 34 when particular circumstances have been met (such as when the participant 34 retires). Benefit 38 may be measured in any suitable manner. For example, benefit 38 may be a weekly income amount that the participant 34 is eligible to receive, a bi-weekly income amount that the participant 34 is eligible to receive, a monthly income amount that the participant 34 is eligible to receive, a yearly income amount that the participant 34 is eligible to receive, a one-time payment amount that the participant 34 is eligible to receive, any other type of measurement of benefit 38, or any combination of the preceding. Benefit 38 may further be measured as the total income amount that is expected to be paid to the participant 34. For example, if a participant 34 is expected to live to the age of 84, benefit 38 may be measured as the total income amount expected to be paid to the participant during the life expectancy of the participant 34 (e.g., the total amount expected to be paid based on payments of $2,000 per month from the age of 65 to the age of 84). Benefit 38 may further include any income amounts expected to be paid to a beneficiary of the participant 34 upon death of the participant 34. For example, after the death of participant 34 at the age of 84, benefit 38 may further include an amount of payments expected to be paid to the participant 34's spouse for the expected remainder of the spouse's life. Pension plan 22 may include any suitable number of benefits 38. For example, pension plan 22 may include one benefit 38 for each participant 34 in pension plan 22. In such an example, if pension plan 22 includes 250,000 participants 34, pension plan 22 may also include 250,000 benefits 38.

Pension plan 22 may be liable to pay for the benefits 38 associated with each participant 34. As an example, if pension plan 22 has 100,000 participants, and the average benefit 38 for each of the participants 34 is $100,000, pension plan 22 may be liable for $10 billion. Furthermore, as the sponsor of pension plan 22, organization 14 may be obligated to pay for one or more deficiencies in pension plan 22. Due to this obligation, organization 14 may be forced to spend a considerable amount of time focusing on its pension obligations instead of spending time focusing on its core business (e.g., building planes, building cars, building engines, providing financial services, etc.) As a result, organization 14 may desire to no longer sponsor pension plan 22 (resulting in the dissolution of pension plan 22). Before this can occur, pension plan 22 may be required to transfer the risk associated with one or more benefits 38 to another entity (such as issuer 18). As is illustrated in FIG. 1A, such a transfer of risk may occur as annuity generation 26.

Annuity generation 26 may represent any suitable transaction that causes the risk for one or more benefits 38 of pension plan 22 to be transferred to issuer 18. As such, issuer 18 may be liable for such benefits 38 going forward, not pension plan 22 or organization 14. Annuity generation 26 may include any manner of transferring the risk for one or more benefits 38 of pension plan 22 to issuer 18. For example, annuity generation 26 may generate an annuity 30 that includes a new version of benefits 38 that may replace the benefits 38 of pension plan 22. In such an example, although issuer 18 may be liable for paying for the benefits 38 included in annuity 30, the benefits 38 of pension plan 30 may not actually be transferred to annuity 30. Instead, new versions of benefits 38 may be generated in annuity 30, and these new versions of benefits 38 may be configured to replicate the terminated benefits 38 of pension plan 22. Furthermore, in such an example, issuer 18 may not assume (or be transferred) the liabilities associated with benefits 38 of pension plan 30. Instead, issuer 18 may generate new liabilities associated with the new version of benefits 38 (which may obligate issuer 18 to pay for the new version of benefits 38), while the liabilities of pension plan 22 and organization 14 may be terminated, defeased, otherwise provided for, or otherwise settled. As another example, annuity generation 26 may include any other manner of transferring the risk for one or more benefits 38 of pension plan 22 to issuer 18, such as generating an annuity 30 that includes a new version of benefits 38 that may replace only a portion of benefits 38 of pension plan 22 (e.g., only a portion of the benefits 38 in pension plan 22 may be settled), converting all (or a portion) of pension plan 22 into annuity 30 in order to generate annuity 30, supplementing all (or a portion) pension plan 22 with an annuity 30 (e.g., annuity payments may be made to pension plan 22 to support benefits 38 owed by pension plan 22), or any combination of the preceding.

Annuity 30 may represent any suitable arrangement to provide eligible participants 34 (or pension plan 22) with an income amount. Examples of annuity 30 may include one or more group annuities, one or more deferred variable annuities, one or more deferred fixed annuities, one or more lifetime immediate annuities, one or more derivative-based transactions, one or more swap-based transactions, one or more trust-based transactions, any other suitable annuities (whether by contracts, insurance products, reinsurance products, other financial arrangements, or other transactions), or any combination of the preceding. The income amount paid to eligible participants 34 may be paid out by issuer 18 during a distribution phase of annuity 30, or any other phase of annuity 30. Such a distribution phase for each participant 34 of annuity 30 may occur following an election by the participant 34 and/or based on one or more terms and conditions of the annuity 30 (and/or the pension plan 22). For example, the distribution phase for a participant 34 may occur following the retirement of the participant 34. Furthermore, annuity 30 may also provide for an accrual phase that may allow one or more participants 34 in annuity 30 to make contributions and/or withdrawals. Additionally, annuity 30 may also provide for an accrual phase that may allow organization 14 (and/or pension plan 22) to make contributions for one or more participants 34.

Annuity 30 may include participants 34 and benefits 38. Participants 34 of annuity 30 may be the same participants 34 that were previously associated with pension plan 22. For example, each of the participants 34 in pension plan 22 may receive their benefits 38 from annuity 30 (causing issuer 18 to be liable for each of the benefits 38). On the other hand, one or more participants 34 of annuity 30 may be different from the participants 34 that were previously associated with pension plan 22. For example, one or more of participants 34 of pension plan 22 may have opted to receive a liability payout 52 for all or a portion of their benefit 38 (causing their benefit 38 or portion of their benefit 38 to not be included in annuity 30), as is disclosed in detail below with regard to liability payout 52.

Furthermore, benefits 38 of annuity 30 may be identical to benefits 38 that were previously associated with pension plan 22. For example, as is discussed above, benefits 38 of annuity 30 may be configured to replicate benefits 38 that were previously associated with pension plan 22. In such an example, if a participant 34 was eligible in pension plan 22 to receive an income amount of $2,000 a month from age 65 until death, annuity 30 may provide such a $2,000 a month payment to participant 34 from age 65 until death. On the other hand, one or more benefits 38 in annuity 30 may be different from the benefits 38 that were previously associated with pension plan 22. For example, as is disclosed below with regard to liability payout 52, a participant 34 may opt to only receive one half of their benefit 38 from annuity 30 (as a result of participant 34 electing to receive the other one half of their benefit 38 through liability payout 52). In such an example, annuity 30 may only provide income amounts of $1,000 per month to participant 34 from the age of 65 until death (as opposed to $2,000 a month from the age of 65 until death).

Benefit 38 of annuity 30 may also be different from the benefit 38 previously associated with pension plan 22 because a participant 34 may be able to change one or more benefit types associated with benefit 38. As an example, in pension plan 22, a beneficiary of a participant 34 may only have been eligible for 50% of the income amount provided by benefit 38 upon the death of participant 34. However, when annuity 30 is generated by annuity generation 26, participant 34 may be able to change the benefit type to provide for 75% of the income amount provided by benefit 38 upon the death of participant 34.

Pension plan 22 may further includes assets 42. Assets 42 may represent any suitable type of assets, such as real property, cash, stocks, bonds, treasuries, private equities, intangible assets, tangible assets, any other suitable type of asset, or any combination of the preceding. Furthermore, assets 42 may also represent any suitable amount of assets. For example, assets 42 may be held by pension plan 22 to pay for benefits 38. In such an example, if pension plan 22 has a liability of $10 billion, assets 42 may have a value of $10 billion, a value less than $10 billion, or a value greater than $10 billion.

In order for the annuity generation 26 to occur between pension plan 22 and issuer 18 (thus resulting in a transfer of risk associated with benefits 38 from pension plan 22 to issuer 18), pension plan 22 may provide a payment of premium 46 to issuer 18. For example, the payment of premium 46 may result in the transfer of all or a portion of assets 42 to issuer 18. The premium amount paid by pension plan 22 in the payment of premium 46 may include any suitable premium amount. For example, the premium amount may represent an amount of assets 42 having a value sufficient to allow issuer 18 to pay each of benefits 38 in annuity 30 as they come due. Furthermore, the premium amount may further include one or more charges associated with the risk to issuer 18 of receiving the risk associated with benefits 38.

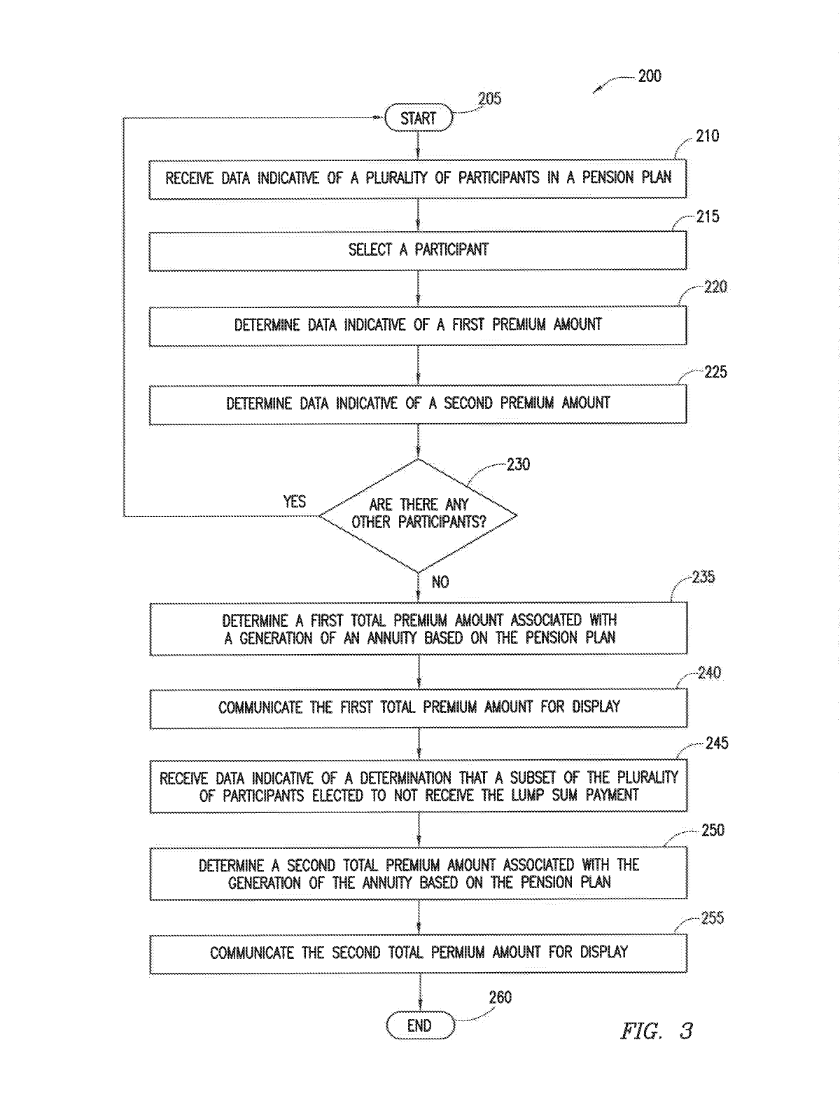

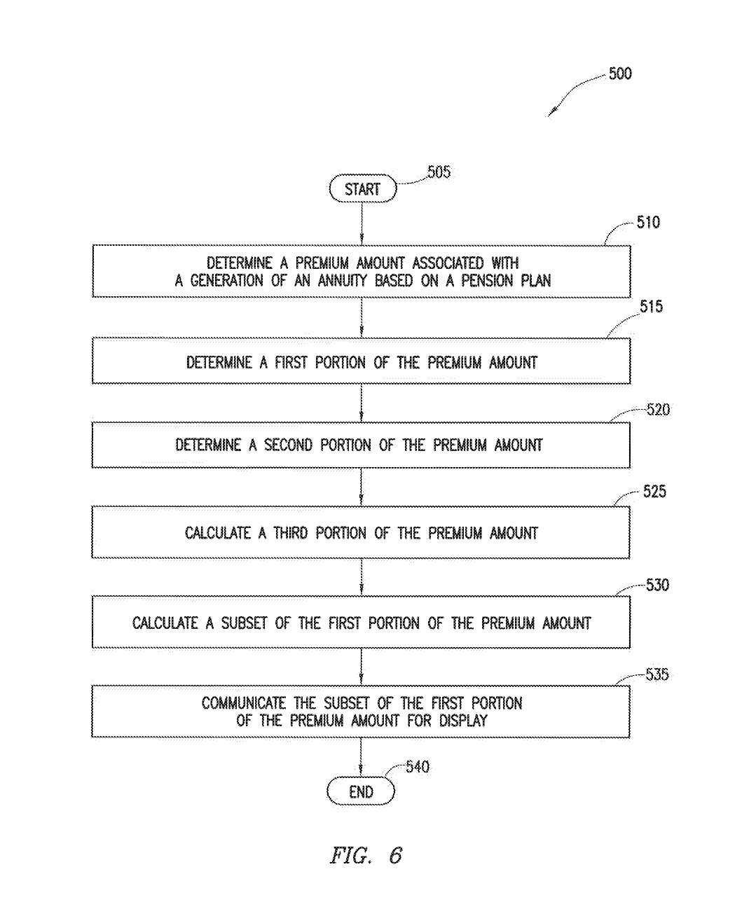

Examples of the calculation and/or adjustment of the premium amount included in the payment of premium 46 are disclosed below with regard to FIGS. 3-5. The premium amount may be calculated and/or adjusted using any suitable combination of the methods of FIGS. 3-5. For example, the premium amount may be calculated and/or adjusted using each of the methods of FIGS. 3-5, only one of the methods of FIGS. 3-5, or any combination of two or more of the methods of FIGS. 3-5. Furthermore, an example of a calculation of an amount of the premium amount that may be allocated to a general account of issuer 18, and a calculation of an amount of the premium amount that may be allocated to a separate account of issuer 18 is disclosed below with regard to FIG. 6. The method of FIG. 6 may be combined with one or more of the methods of FIGS. 3-5. For example, the method of FIG. 6 may be combined with each of the methods of FIGS. 3-5, only one of the methods of FIGS. 3-5, or any combination of two or more of the methods of FIGS. 3-5.

As is further illustrated in FIG. 1A, pension plan 22 may also provide liability payout 52 to one or more participants 34 in pension plan 22. Liability payout 52 may represent any type of payment (e.g., a lump sum payment, a group of payments, etc.) to a participant 34 in pension plan 22 that satisfies all or a portion of benefit 38 of the participant 34. As an example, liability payout 52 may include a payment paid to a participant 34 in order to satisfy the entire benefit 38 associated with the participant 34. In such an example, if an entire benefit 38 is satisfied by liability payout 52 from pension plan 22, the liability for benefit 38 may be terminated (or otherwise settled), and that benefit 38 may not be included in annuity 30. Furthermore, liability payout 52 may change which participants 34 of pension plan 22 become participants 34 of annuity 30. For example, if pension plan 22 includes 250,000 participants 34, but 30,000 of those participants 34 receive a liability payout 52 (which satisfies their associated benefits 38), only 230,000 participants 34 may become participants 34 of annuity 30 (causing issuer 18 to be liable for their respective benefits 38). As another example, liability payout 52 may only satisfy a portion of a participant 34's benefit 38. In such an example, only a portion of benefit 38 of a participant 34 may have been eligible for liability payout 52. As such, even if the participant 34 accepts liability payout 52 for that portion of benefit 38, the remaining portion of benefit 38 may be included in annuity 30 (and issuer 18 may be liable to pay for the remaining portion of benefit 38 going forward).

Any suitable number of participants 34 in pension plan 22 may be eligible to accept a liability payout 52 as satisfaction of all or a portion of their benefit 38 (resulting in all or a portion of that benefit 38 not being included in annuity 30). For example, each of the participants 34 in pension plan 22 may be eligible to accept a liability payout 52 as satisfaction of all or a portion of their benefit 38. As another example, only a portion of the participants 34 in pension plan 22 may be eligible to accept a liability payout 52 as satisfaction of all or a portion of their benefit 38. A participant 34's eligibility for a liability payout 52 (and the amount of benefit 38 that is eligible for satisfaction by a liability payout 52) may be determined in any suitable manner. For example, whether or not a participant 34 may be eligible for a liability payout 52 (and the amount of benefit 38 that may be eligible for a liability payout 52) may be based on the age of the participant 34, the number of years that the participant 34 has been participating in pension plan 22, the amount of benefit 38 associated with participant 34, any other suitable factor, or any combination of the preceding. As an example, a participant 34 may only be eligible for a liability payout 52 if the participant 34 has been participating in the pension plan 22 for more than 20 years. As another example, the benefit 38 that is eligible to be satisfied by a liability payout 52 may only include an amount of benefit 38 that has already vested in the participant 34.

Modifications, additions, or omissions may be made to the transaction 10 without departing from the scope of the disclosure. For example, issuer 18 may be more than one entity. Furthermore, one or more elements of the transaction 10 may be integrated or separated.

FIG. 1B illustrates an example timeline 60 for a generation of an annuity 30 based on a pension plan 22 according to one embodiment of the present disclosure. As is disclosed above in FIG. 1A, pension plan 22 (and/or organization 14) and issuer 18 may utilize annuity generation 26 to transfer risk associated with one or more benefits 38 from the pension plan 22 to the issuer 18. Such an annuity generation 26 (and the transfer of risk caused by the annuity generation 26) may occur in accordance with timeline 60 of FIG. 1B.

Timeline 60 includes a first time point 64 and a second time point 68. First time point 64 may represent the time (i.e., a date and/or a time such as, for example, Jun. 15, 2015 at 3:00 PM) when pension plan 22 and issuer 18 sign an agreement for an annuity generation 26 that may occur at the second time point 68. The agreement signed at first time point 64 may represent any suitable agreement that may contractually obligate pension plan 22 and issuer 18 under one or more conditions to participate in annuity generation 26 if the one or more conditions of the agreement are met at the second time point 68. Second time point 68 may represent the time (i.e., a date and/or a time, such as, for example, Dec. 15, 2015 at 2:00 PM) when the closing date of the agreement actually occurs, and further when the annuity generation 26 actually occurs (resulting in the transfer of risk associated with benefits 38) Furthermore, second time point 68 may further represent the time at which pension plan 22 provides the payment of premium 46 to issuer 18.

Pension plan 22 may have various reasons for utilizing at least two time points (e.g., first time point 64 and second time point 68) for annuity generation 26. For example, pension plan 22 may desire to receive a contractual obligation from issuer 18 before pension plan 22 may begin allowing participants 34 to elect to receive a liability payout 52. As another example, pension plan 22 may desire the time in-between first time point 64 and second time point 68 to accumulate a particular set of assets 42 that may be acceptable to issuer 18 as the payment of premium 46.

However, although pension plan 22 may have various reasons for utilizing at least two time points in order to provide for the annuity generation 26, pension plan 22 may desire to understand the cost of the annuity generation 26 that will occur at second time point 68 prior to signing the agreement at first time point 64. In order to provide such an understanding, issuer 18 may determine a preliminary premium associated with the annuity generation 26. The preliminary premium may represent a premium that would be payable by pension plan 22 to issuer 18 if the annuity generation 26 (and the resulting transfer of risk) occurred at the first time point 64 (as opposed to the second time point 68). The preliminary premium may allow pension plan 22 and issuer 18 to both understand how the final premium (i.e., the final premium amount that will be paid by pension plan 22 to issuer 18 when the annuity generation 22 occurs at second time point 68) will be calculated and/or adjusted for the time period in-between the first time point 64 and the second time point 68 (even though one or more variable associated with the generation (and the resulting transfer of risk) may not yet be known at the first time point 64). Furthermore, preliminary premium may also allow pension plan 22 and issuer 18 to both understand how an amount of the final premium that may be allocated to a general account will be calculated, and how an amount of the final premium that may be allocated to a separate account will be calculated.

Although the preliminary premium may allow pension plan 22 and issuer 18 to both understand how the final premium (i.e., the final premium amount that will be paid by pension plan 22 to issuer 18 when the annuity generation 26 occurs at second time point 68) will be calculated and/or adjusted, the preliminary premium may not be the same amount as the final premium amount paid at the second time point 68 because one or more variables associated with the annuity generation 26 may be unknown at the first time point 64. As an example, the amount of benefits 38 that will be included in annuity 30 may be unknown at the first time point 64. In such an example, these benefits 38 may be unknown at the first time point 64 because one or more of benefits 38 may be satisfied by liability payouts 52 in-between the first time point 64 and the second time point 68, one or more benefit types may change for one or more of the participants 34 (e.g., such as if a participant 34 changes the amount a beneficiary is expected to receive from the annuity 30) in-between first time point 64 and second time point 68, one or more of the participants 34 of pension plan 22 may die in-between the first time point 64 and the second time point 68, any other suitable reason, or any other combination of the preceding. Furthermore, the preliminary premium may also not be the same as the final premium paid at the second time point 68 because prevailing market conditions may fluctuate in-between first time point 64 and second time point 68. Additionally, the preliminary premium may also not be the same as the final premium paid at the second time point 68 because the assets 42 provided by pension plan 22 to issuer 18 may be different (e.g., the assets 42 may have a different duration) than what was agreed to at the first time point 64.

Once each of these unknown variables finally become known (e.g., which may occur sometime in-between first time point 64 and second time point 68), issuer 18 may then determine the final premium to be paid by pension plan 22. As such, pension plan 22 may pay the final premium via the payment of premium 46, and issuer 18 may become liable for the benefits 38 included in annuity 30.

Modifications, additions, or omissions may be made to the timeline 60 without departing from the scope of the disclosure. For example, timeline 60 may include more than two time points. Furthermore, although the agreement for the annuity generation 26 has been disclosed above as being in-between the pension plan 22 and the issuer 18, the agreement may be by and among pension plan 22, organization 14, issuer 18, and/or any other interested parties (e.g., fiduciaries). As such, in one example, pension plan 22, organization 14, issuer 18, and/or any other interested parties may be contractually obligated under one or more conditions to participate in annuity generation 26 if the one or more conditions of the agreement are met at the second time point 68. Furthermore, each of pension plan 22, organization 14, and/or any other interested parties may also provide payment of premium 46 to issuer 18 at the second time point 68.

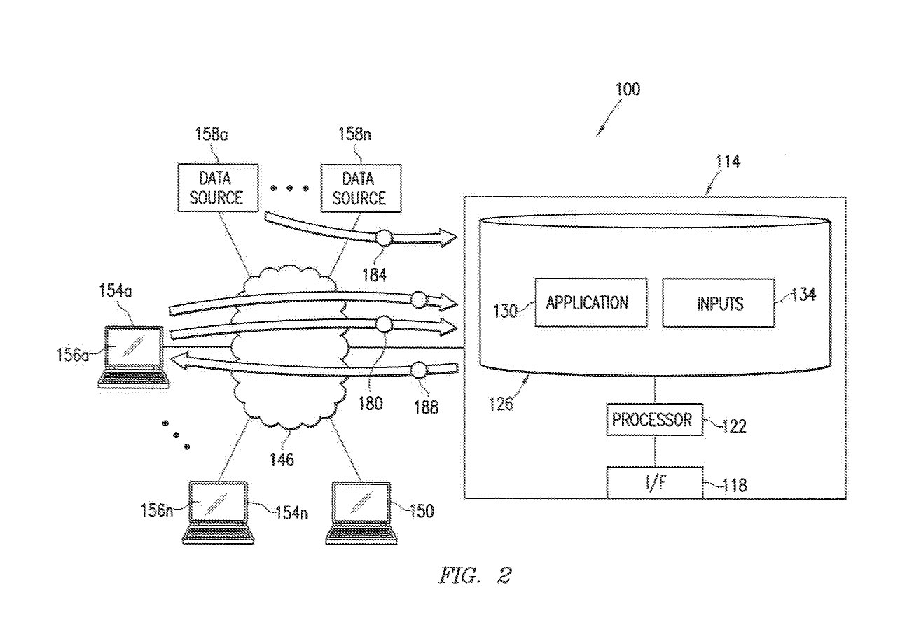

FIG. 2 illustrates a system 100 for providing calculations and/or adjustments associated with premium amounts for a generation of an annuity 30 based on a pension plan 22 according to one embodiment of the present disclosure. For example, system 100 may calculate and/or adjust a preliminary premium amount, thereby allowing pension plan 22 and issuer 18 to both understand how the final premium (i.e., the final premium amount that will be paid by pension plan 22 to issuer 18 when the annuity generation 26 occurs at second time point 68) will be calculated and/or adjusted for the time period in-between the first time point 64 and the second time point 68. As another example, system 100 may calculate and/or adjust a final premium amount, thereby allowing pension plan 22 and issuer 18 to view the final premium for the annuity generation 26 when adjusted for changes that occurred in-between the first time point 64 and the second time point 68. As such, pension plan 22 can provide the correct payment of premium 46 to issuer 18, and annuity generation 26 may occur. As a further example, system 100 may calculate an amount (such as amount of the final premium) that may be allocated to a general account, and calculate an amount (such as amount of the final premium) that may be allocated to a separate account. As such, pension plan 22 and issuer 18 may be able to understand how payment of benefits 38 of annuity 30 will be guaranteed by issuer 18.

Calculation device 114 may represent any components that provide calculations and/or adjustments associated with premium amounts for a generation of an annuity 30 based on a pension plan 22, and may be implemented using any suitable combination of hardware, firmware, and software. Calculation device 114 may include a network server, any remote server, a mainframe, a host computer, a workstation, a web space server, a personal computer, a file server, or any other device operable to provide calculations and/or adjustments associated with premium amounts for a generation of an annuity 30 based on a pension plan 22. The functions of calculation device 114 may be performed by any combination of one or more servers or other components at one or more locations. If the module is a server, the server may be a private server, and the server may be a virtual or physical server. The server may include one or more servers at the same or remote locations. Also, calculation device 114 may include any component that functions as a server. As illustrated, calculation device 114 includes a network interface 118, a processor 122, and a memory 126.

Network interface 118 may represent any device operable to receive information from network 146, transmit information through network 146, perform processing of information, communicate to other devices, or any combination of the preceding, and may be implemented using any suitable combination of hardware, firmware, and software. For example, network interface 118 may receive information from a data source 158. As another example, network interface 118 may communicate premium amounts for display on a user device 154. Network interface 118 may represent any port or connection, real or virtual, including any suitable hardware and/or software, including protocol conversion and data processing capabilities, to communicate through a local area network (LAN), a metropolitan area network (MAN), a wide area network (WAN), or other communication system that allows calculation device 114 to exchange information with network 146, administration device 150, user devices 154, data sources 158, or other components of system 100.

Processor 122 communicatively couples to network interface 118 and memory 126, and controls the operation and administration of calculation device 114 by processing information received from network interface 118 and memory 126. For example, processor 122 executes calculation device management application 130 to control the operation of calculation device 114. Processor 122 may be a programmable logic device, a microcontroller, a microprocessor, any processing device, or any combination of the preceding.

Memory 126 stores, either permanently or temporarily, data, operational software, or other information for processor 122. Memory 126 includes any one or a combination of volatile or non-volatile local or remote devices suitable for storing information. For example, memory 126 may include random access memory (RAM), read only memory (ROM), magnetic storage devices, optical storage devices, or any other information storage device or a combination of these devices. While illustrated as including particular modules, memory 126 may include any information for use in the operation of calculation device 114.

As illustrated, memory 126 includes calculation device management application 130 and inputs 134. Calculation device management application 130 may represent any suitable set of instructions, logic, or code embodied in a computer readable storage medium and operable to facilitate the operation of calculation device 114.

Inputs 134 represent any information that may be provided to calculation device 114. Examples of inputs 134 may include any information that may be used to calculate and/or adjust premium amounts, any information that may be used to calculate an amount of the premium amounts that may be allocated to a general account, any information that may be used to calculate an amount of the premium amounts that may be allocated to a separate account, data indicative of a plurality of participants 34 in a pension plan 22, data indicative of assets 42, data indicative of one or more reference portfolios, expected and actual market values of one or more assets, one or more mortality tables, one or more characteristics associated with assets 42, data indicative of one or more thresholds associated with assets 42, one or more rules, any other suitable information that may be used to provide calculations and/or adjustments associated with premium amounts for a generation of an annuity 30 based on a pension plan 22, or any combination of the preceding. Inputs 134 may be provided to calculation device 114 in any suitable manner. For example, a user (using the administration device 150 or the user device 154) may provide inputs 134 to calculation device 114. As another example, data sources 158 may provide inputs 134 to calculation device 114.

Network 146 may represent any network operable to facilitate communication between the components of system 100, such as calculation device 114, administration device 150, user devices 154, and data sources 158. Network 146 may include any interconnecting system capable of transmitting audio, video, signals, data, messages, or any combination of the preceding. Network 146 may include all or a portion of a public switched telephone network (PSTN), a public or private data network, a LAN, a MAN, a WAN, a local, regional, or global communication or computer network, such as the Internet, a wireline or wireless network, an enterprise intranet, or any other communication link, including combinations thereof, operable to facilitate communication between the components.

Administration device 150 may represent any components that allow a user of the administration device 150 (such as an administrator) to control calculation device 114 and/or provide information to calculation device 114 (such as provide inputs 134 to calculation device 114). Administration device 150 may include a personal computer, a workstation, a laptop, a wireless or cellular telephone, an electronic notebook, a personal digital assistant, or any other device (wireless, wireline, or otherwise) capable of receiving, processing, storing, and/or communicating information with other components of system 100 in order to allow a user to control calculation device 114 and/or provide information to calculation device 114. Administration device 150 may comprise a user interface, such as a display, a microphone, keypad, or other appropriate terminal equipment usable by a user.

User device 154 may represent any components that may display information received from calculation device 114. User device 154 may include a personal computer, a workstation, a laptop, a wireless or cellular telephone, an electronic notebook, a personal digital assistant, or any other device (wireless, wireline, or otherwise) capable of receiving, processing, storing, and/or communicating information with other components of system 100 in order to display information received from calculation device 114. User device 154 may further allow a user to request information from calculation device 114 and/or provide information to calculation device 114. For example, in order to determine premium amounts associated a generation of an annuity 30 based on a pension plan 22, a user may provide one or more inputs 134 and/or one or more requests 189 to calculation device 114 in order for calculation device to calculate and/or adjust the premium amounts. User device 154 may comprise a user interface, such as a display, a microphone, keypad, or other appropriate terminal equipment usable by a user.

User device 154 may display a graphical user interface 156 in order to allow a user to view the information provided by calculation device 114. Graphical user interface 156 may include any graphical interface that allows the user to view information provided by calculation device 114, request information from calculation device 114, and/or provide information to calculation device 114. For example, graphical user interface 156 may allow a user to input one or more pieces of information (such as inputs 134) to transmit to calculation device 114. Furthermore, graphical user interface 58 may be accessible to a user through a web browser.

Although FIG. 2 illustrates system 100 as only including two user devices 154 (user device 154a and user device 154n), system 100 may include any suitable number of user devices 154. For example, system 100 may include less than two user devices 154 or more than two user devices 154.

Data source 158 may represent any source of information that may be used by calculation device 114. Data source 158 may include a device (such as a database, a personal computer, a workstation, a laptop, a wireless or cellular telephone, an electronic notebook, a personal digital assistant, or any other device capable of receiving, processing, storing, and/or communicating information), a person (such as a person who has knowledge of a pension plan 22 and who provides such knowledge for communication to a calculation device 114), the Internet (which may include information about one or more assets 42), any other suitable source of information, or any combination of the preceding. As is illustrated, calculation device 114 may receive information from data sources 158 in order to provide calculations and/or adjustments associated with premium amounts for a generation of an annuity 30 based on a pension plan 22. For example, data source 158 may include one or more devices associated with pension plan 22. These devices may provide information regarding the pension plan 22 (such as information regarding participants 34, benefits 38, etc.). As another example, data source 158 may include one or more devices associated with third parties (such as Moody's Investors Service, Barclays Investment Bank, Standard & Poor's, etc.) that may be used to provide calculations and/or adjustments associated with premium amounts for a generation of an annuity 30 based on a pension plan 22.

Although FIG. 2 illustrates calculation device 114, administration device 150, user devices 154, and data sources 158 as separate components, in particular embodiments, two or more of the calculation device 114, administration device 150, user devices 154, and data sources 158 may be the same component. For example, the calculation device 114, administration device 150, and user devices 154 may be the same device. As such, a user may view the premiums amounts and/or transmit inputs 134 at the same device that provides calculations and/or adjustments associated with premium amounts. As another example, data sources 158 may be the same device as user devices 154. As such, calculation device 114 may receive information from the same device that displays premium amounts.

In an example embodiment of operations, in order to determine and view premium amounts (or amounts that may be allocated to a general account or a separate account) associated with the generation of an annuity 30 based on a pension plan 22, a user may transmit a request 180 to calculation device 114. Request 180 may represent a request for any suitable calculation and may include any suitable information to facilitate calculation of data by calculation device 114. For example, request 180 may include a request for a preliminary premium amount associated with the generation of an annuity 30 based on a pension plan 22, an adjusted preliminary premium amount associated with the generation of an annuity 30 based on a pension plan 22, a final premium amount associated with the generation of an annuity 30 based on a pension plan 22, an adjusted final premium amount associated with the generation of an annuity 30 based on a pension plan 22, any other suitable premium amount associated with the generation of an annuity 30 based on a pension plan 22, one or amounts of a premium amount (such as a preliminary amount, an adjusted preliminary amount, a final premium amount, and/or a final adjusted premium amount) that may be allocated to a general account of the issuer 18 and/or a separate account of the issuer 18, and/or any other suitable request.

In response to receiving request 180, calculation device 114 may perform any type of calculation associated with premium amounts. As an example, calculation device 114 may calculate and/or adjust a preliminary premium amount, a final premium amount, any other premium amount associated with the generation of an annuity 30 based on a pension plan 22, or any combination of the preceding. As a further example, calculation device 114 may calculate one or more amounts of a premium amount that may be allocated to a general account of an issuer 18 and/or a separate account of an issuer 18. In order to do so, calculation device 114 may conduct various steps (disclosed below). Additionally, in order to perform one or more of the following steps, calculation device 114 may further receive information 184 from data sources 188. Furthermore, although FIG. 2 illustrates information 184 as having been received from data sources 158, information 184 may be received from any other component of system 100 (such as if a user receives the information 184 from data sources 158 and communicates the received information 184 to calculation device 114) and/or from an input directly into calculation device 114 (such as by a keyboard of calculation device 114). Information 184 may include any information received from data sources 158 and used by calculation device 114 to provide calculations and/or adjustments associated with the generation of an annuity 30 based on a pension plan 22.

Based at least on the information disclosed above, calculation device 114 may provide calculations and/or adjustments associated with premium amounts. Calculation device may then communicate the calculated and/or adjusted premium amounts (or the amounts of the premium amount that may be allocated to a general account and/or a separate account) as results 188 for display at user device 154. In order to provide calculations and/or adjustments associated with premium amounts (or the amounts of the premium amount that may be allocated to a general account and/or a separate account), calculation device may perform one or more of the steps of one or more of FIGS. 3-6 disclosed below.

Modifications, additions, or omissions may be made to the system 100 without departing from the scope of the disclosure. Furthermore, one or more elements of the system 100 may be integrated or separated. For example, user device 154 and calculation device 114 may be the same device.

FIG. 3 illustrates a method 200 for calculating premium amounts associated with a generation of an annuity based on a pension plan according to one embodiment of the present disclosure. One or more steps of method 200 may be performed by calculation device 114 of FIG. 2.

The method begins at step 205. At step 210, data indicative of a plurality of participants 34 in a pension plan 22 is received. The data indicative of the plurality of participants 34 may include any type of information associated with one or more participants 34. For example, the data may include an identifier of a participant 34 (such as the name of the participant 34 or an identification number associated with the participant 34), the age of the participant 34, the gender of the participant 34, one or more benefits 38 associated with the participant 34, whether or not the participant 34 is eligible for a liability payout 52, any other suitable information associated with the participant 34, or any combination of the preceding. The data indicative of the plurality of participants 34 may be received in any suitable manner. As an example, the data may be manually input into calculation device 114 of FIG. 2 by a user or an administrator. As another example, the data may be downloaded (or otherwise communicated) from a data source 158 of FIG. 2. The data indicative of a plurality of participants 34 may include information for any suitable number of participants 34 in the pension plan 22. For example, the data may include information for each of the participants 34 in the pension plan 22 or only a portion of the participants 34 in the pension plan 22. In such an example, the data may include information for two participants 34, 100 participants 34, 1,000 participants 34, 10,000 participants 34, 100,000 participants 34, 1 million participants 34, or any other suitable number of participants 34.

At step 215, a participant 34 is selected. Any of the participants 34 may be selected, and the participant 34 may be selected in any suitable manner. Once the participant 34 is selected at step 215, one or more steps of method 200 (such as steps 220 and 225 of method 200) may be performed for that particular selected participant 34.

At step 220, data indicative of a first premium amount is determined. The first premium amount may be associated with a benefit 38 of the pension plan 22 that the participant 34 is not eligible to elect to receive as a liability payout 52. For example, as is disclosed above with regard to FIG. 1A, one or more participants 34 in pension plan 22 may not be eligible to receive liability payout 52 at all (or may not be eligible to receive liability payout 52 for a portion of their benefit 38). As such, these participants 34 may not be eligible to elect to receive a liability payout 52 (e.g., such as a lump sum payment) to satisfy any or a portion of their benefit 38. Therefore, these benefits 38 will be included in annuity 30 (and issuer 18 will be liable for these benefits 38 once annuity generation 26 occurs). In light of this, issuer 18 may charge a first premium amount associated with these benefits 38.

The first premium amount may include any suitable amount. For example, the first premium amount for a participant 34 may be an amount that will satisfy the benefit 38 for that participant 34. As another example, the first premium amount for a participant 34 may further include one or more premium charges charged by issuer 18 to be liable for benefit 38 and also charged by issuer 18 to manage annuity 30. The first premium amount may be determined based on any suitable information regarding the participant 34 and the benefit 38. For example, the first premium amount may be determined based on the age of the participant 34, the gender of the participant 34, the amount of the benefit 38, the present and future values of the benefit 38, one or more mortality tables, one or more expenses associated with the generation and/or management of annuity 30, any other factor, or any combination of the preceding. As an example of the first premium amount, if $0 (zero) of the participant 34's benefit 38 is not eligible for the liability payout 52 (e.g., meaning that all of the participant 34's benefit 38 is eligible for the liability payout 52), the first premium amount for that participant 34 may be an amount of $0 (zero). As another example of the first premium amount, if $100,000 of the participant 34's benefit 38 is not eligible for the liability payout 52, the first premium amount for that participant 34 may be, for example, $105,000 ($100,000+5% premium charges by issuer 18=$105,000). As a further example of the first premium amount, if $75,000 of the participant 34's benefit 38 is not eligible for the liability payout 52 (while $25,000 of the participant 34's benefit 38 is eligible for the liability payout 52), the first premium amount for that participant 34 may be, for example, $78,750 ($75,000+5% premium charges by issuer 18=$78,750).

The data indicative of the first premium amount may include any suitable information that may represent the first premium amount (e.g., such as any suitable information that may represent $105,000). Furthermore, the data indicative of the first premium amount may be determined in any suitable manner. For example, the data indicative of the first premium amount may be received at calculation device 114 based on an input from a user and/or administrator. In such an example, the user may review information associated with the participant 34 and their benefit 38, and may determine the first premium amount for input into calculation device 114. As another example, the data indicative of the first premium amount may be calculated by calculation device 114. In such an example, the calculation device 114 may access the data indicative of the respective participant 34, may further access one or more factors associated with the first premium amount (e.g., one or more mortality tables, the present and future value of the benefit 38, etc.), and may calculate the first premium amount using the accessed information.

At step 225, data indicative of a second premium amount is determined. The second premium amount may be associated with a benefit 38 of the pension plan 22 that the participant 34 is eligible to elect to receive as a liability payout 52. For example, as is disclosed above with regard to FIG. 1A, one or more participants 34 in pension plan 22 may be eligible to receive liability payout 52 for all or a portion of their benefit 38. As such, these participants 34 may be eligible to elect to receive a liability payout 52 to satisfy any or a portion of their benefit 38. Therefore, the benefits 38 that are eligible to be satisfied by the liability payout 52 may only be included in annuity 30 if the liability payout 52 is not elected by the participant 34 (which may not be known when the second premium amount is determined). Because these benefits 38 may eventually be included in annuity 30, issuer 18 may determine a second premium amount for these benefits 38 (even though these benefits 38 may never be included in annuity 30 and issuer 18 may never be liable for these benefits 38).

The second premium amount may include any suitable amount. For example, the second premium amount for a participant 34 may be an amount that will satisfy the benefit 38 for that participant 34. As another example, the second premium amount for a participant 34 may further include one or more premium charges charged by issuer 18 to be liable for benefit 38, to manage annuity 30, and also for uncertainty regarding whether or not benefit 38 will be satisfied by a liability payout 52. The second premium amount may be based on any suitable information regarding the participant 34 and the benefit 38. For example, the second premium amount may be based on the age of the participant 34, the gender of the participant 34, the amount of the benefit 38, the present and future values of the benefit 38, one or more mortality tables, one or more expenses associated with the generation and/or management of annuity 30, one or more expenses associated with the uncertainty regarding whether or not the benefit 38 will be satisfied by a liability payout 52, any other factor, or any combination of the preceding. As an example of the second premium amount, if $0 (zero) of the participant 34's benefit 38 is eligible for the liability payout 52, the second premium amount for that participant 34 may be an amount of $0 (zero). As another example of the second premium amount, if $100,000 of the participant 34's benefit 38 is eligible for the liability payout 52, the second premium amount for that participant 34 may be, for example, $110,000 ($100,000+5% premium charges by issuer 18+an additional 5% charges for the uncertainty regarding whether or not the benefit 38 will be satisfied by a liability payout 52=$110,000). As a further example of the second premium amount, if $25,000 of the participant 34's benefit 38 is eligible for the liability payout 52 (while $75,000 of the participant 34's benefit 38 is not eligible for the liability payout 52), the second premium amount for that participant 34 may be, for example, $27,500 ($25,000+5% premium charges by issuer 18+an additional 5% charges for the uncertainty regarding whether or not the benefit 38 will be satisfied by a liability payout 52=$27,500).

The data indicative of the second premium amount may include any suitable information that may represent the second premium amount (e.g., such as any suitable information that may represent $110,000). Furthermore, the data indicative of the second premium amount may be determined in any suitable manner. For example, the data indicative of the second premium amount may be received at calculation device 114 based on an input from a user and/or administrator. In such an example, the user may review information associated with the participant 34 and their benefit 38, and may determine the second premium amount for input into calculation device 114. As another example, the data indicative of the second premium amount may be calculated by calculation device 114. In such an example, the calculation device 114 may access the data indicative of the respective participant 34, may further access one or more factors associated with the second premium amount (e.g., one or more mortality tables, the present and future value of the benefit 38, one or more expenses associated with the uncertainty regarding whether or not the benefit 38 will be satisfied by a liability payout 52, etc.), and may calculate the second premium amount using the accessed information.

At step 230, it is determined whether there are any other participants 34 in the pension plan 22 for which the first and second premiums have not been determined. If there are additional participants 34 in the pension plan 22, method 200 may move back up to step 215 where a participant 34 is selected. As such, steps 215-225 of method 200 may be repeated for each participant 34 in the pension plan 22. On the other hand, if there are not any other participants 34 in the pension plan 22, method 200 may move to step 235.

At step 235, a first total premium amount associated with the generation of the annuity 30 based on the pension plan 22 is determined. The first total premium amount may represent an example premium amount for including all of the benefits 38 of pension plan 22 in annuity 30. The first total premium amount may represent an example of the preliminary premium disclosed above with regard to FIGS. 1A-1B. As such, the first total premium amount may allow pension plan 22 and issuer 18 to both understand how the final premium (i.e., the final premium amount that will be paid by pension plan 22 to issuer 18 when the annuity generation 26 occurs at the second time point 68) will be calculated and/or adjusted for the time period in-between the first time point 64 and the second time point 68.

The first total premium amount may be determined based at least in part on the first premium amount for each of the plurality of participants 34 and the second premium amount for each of the plurality of participants 34. The first total premium amount may be determined in any suitable manner. For example, the first total premium amount may be determined by summing each of the first premium amounts (which are associated with the benefit 38 of the pension plan 22 that a participant 34 is not eligible to elect to receive as a liability payout 52) and each of the second premium amounts (which are associated with the benefit 38 of the pension plan 22 that the participant 34 is eligible to elect to receive as a liability payout 52). In such an example, if the pension plan 22 includes, for example, 250,000 participants 34, the first premium amounts and the second premium amount for each of the 250,000 participants 34 may be added together in order to determine the first total premium amount prior to any participants 34 electing to not receive (or receive) the liability payout 52.

Once the first total premium amount is determined, the method may move to step 240, where the first total premium amount is communicated for display. Such a communication may allow the first total premium amount to be viewed, such as viewed by pension plan 22 and/or issuer 18. As such, pension plan 22 and issuer 18 may both be able to understand how the cost for the annuity generation 26 will be determined and/or adjusted, even though one or more variables associated with the annuity generation 26 (such as which benefits 38 may be satisfied by the liability payout 52) may still be unknown.

At step 245, data indicative of a determination that a subset of the plurality of the participants 34 have elected to not receive the liability payout is received. The data indicative of the determination that a subset of the plurality of the participants 34 have elected to not receive the liability payout may include any suitable information. For example, this data may include an identifier of each participant 34 that elected to not receive the liability payout 52, an identifier of each participant 34 that elected to receive the liability payout 52, any other suitable information, or any combination of the preceding. By receiving this data, issuer 18 may now have a finalized (or more accurate) version of which benefits 38 may be included in annuity 30 when annuity generation 26 occurs. For example, prior to receiving this data, issuer 18 may have based the first total premium amount on the idea that all of the benefits 38 of pension plan 22 would be included in annuity 30. However, after this data is received, issuer 18 may have a final (or more accurate) version of which benefits 38 will be included in annuity 30 when annuity generation 26 occurs, and which benefits 38 will not be included in annuity 30 when annuity generation 26 occurs (i.e., these benefits 38 have been satisfied by the liability payout 52).

The data indicative of a determination that a subset of the plurality of the participants 34 have elected to not receive the liability payout 52 may be received in any suitable manner. As an example, the data may be manually input into calculation device 114 of FIG. 2 by a user or an administrator. As another example, the data may be downloaded (or otherwise communicated) from a data source 158 of FIG. 2.

At step 250, a second total premium amount associated with the generation of the annuity 30 based on the pension plan 22 is determined. The second total premium amount may represent an example premium amount for including only a portion of benefits 38 of pension plan 22 in annuity 30 when annuity generation 26 occurs. For example, the second total premium amount may only include the benefits 38 that were not satisfied by the liability payout 52 and the benefits 38 that were not eligible for the liability payout 52. The second total premium amount may represent an example of the final premium disclosed above with regard to FIGS. 1A-1B. As such, the second total premium amount may be the final premium that pension plan 22 pays to issuer 18 for annuity generation 26.

The second total premium amount may be based at least in part on the first premium amount for each of the plurality of participants 34 and the second premium amount for each of the subset of the plurality of the participants 34. For example, when the pension plan 22 includes, for example, 250,000 participants, the second total premium amount may be based on the first premium amount for each of those 250,000 participants 34 and may be further based on the second premium amount for only, for example, 200,000 of the participants 34 (i.e., when 50,000 of the participants 34 elect to receive the liability payout 52, and 200,000 of the participants 34 elect to not receive the liability payout 52). The second total premium amount may be determined in any suitable manner. An example of the determination of the second total premium amount is disclosed below.

First, the plurality of participants 34 may be organized into a plurality of groups of participants 34. For example, each of the participants 34 may be organized into groups based on age (e.g., a first group of less than 55 years old, a second group of 55-59 year olds, a third group of 60-64 year olds, a fourth group of 65-69 year olds, a fifth group of 70-74 year olds, a sixth group of 75-79 year olds, a seventh group of 80-84 years olds, an eight group of greater than or equal to 85 years old). As another example, each of the participants 34 may be organized into groups based on gender (e.g., a first group of male participants 34 and a second group of female participants 34). As a further example, each of the participants 34 may be organized into groups based on both age and gender (e.g., a first group of males less than 55 years old, a second group of females less than 55 years old, etc.). Furthermore, each of the participants 34 may be organized into any other suitable groups.

Second, a risk factor may be determined for each of the groups of participants 34. The risk factor for a group may represent an amount of risk to issuer 18 caused by issuer 18 agreeing to take on liability for benefits 38 of the pension plan 22 prior to issuer 18 knowing which benefits 38 will be included in annuity 30. For example, as is disclosed above, issuer 18 may agree to be liable for any and all benefits 38 of pension plan 22. This agreement may occur without issuer 18 knowing which of those benefits 38 will be satisfied by liability payouts 52 (which may increase the amount of risk imposed on the issuer 18). This risk to the issuer 18 may be the result of issuer 18 putting itself in a position to potentially be liable for benefits 38 associated with only extremely healthy participants 34 (as opposed to a mix of healthy and unhealthy participants 34). Such a risk could be financially detrimental to the issuer 18 because it is typically more expensive for an issuer 18 to provide an annuity to a group of only extremely healthy participants 34 than it is to provide an annuity to an average group composed of both unhealthy and healthy participants 34. One example reason for this additional expense may be that the healthy participant 34 may be more likely to live longer than the unhealthy participant 34, and therefore, the healthy participant 34 may be more likely to receive more annual income amounts than the non-healthy participant. In order to limit this risk of a skewed population to issuer 18, a risk factor may be utilized to compensate issuer 18 for the uncertainty in benefits 38 that it may be liable for when annuity generation 26 occurs.

The risk factor may be determined in any suitable manner. As an example, the risk factor for each group may be based on the percentage of participants 34 in that group that elect to receive the liability payout 52. In such an example, if 1,000 participants 34 in the 55-59 age group are eligible for the liability payout 52, and 100 of those participants 34 elect to receive the liability payout 52, an initial risk variable of 10% may be determined for the age group of 55-59 year olds. Furthermore, this initial risk variable may be adjusted based on the number of the participants 34 in the age group who elect to change a benefit type associated with the pension plan 22. For example, if there are 10,000 participants 34 in the 55-59 age group, and 1,000 of those participants 34 elect to change their benefit type (e.g., changing the benefit type so that 75% of the income amount of benefit 38 is paid to a beneficiary upon the death of the participant 34, as opposed to 50%), the initial risk variable may be adjusted by 5% ((1,000/10,000)*50% change factor=5%). Therefore, in such an example, the initial risk variable may be 15% (10%+5%=15%), as opposed to 10%. Furthermore, the initial risk variable may be converted (using interpolation) into a risk factor based on, for example, the following calculation rules:

| | Risk Factor | | | | | |
|---|---|---|---|---|---|---|
| Age Group | 0% | 4% | 10% | 20% | 50% | 100% |
| <55 | 85.0% | 85.5% | 92.0% | 96.0% | 110.03% | 120.5% |
| 55-59 | 84.5% | 85.0% | 91.5% | 95.5% | 110.5% | 125.0% |
| 60-64 | 84.0% | 84.5% | 91.0% | 94.0% | 110.5% | 130.0% |
| 65-69 | 83.5% | 83.5% | 90.5% | 94.5% | 111.0% | 135.5% |
| 70-74 | 83.0% | 82.5% | 90.0% | 94.5% | 111.5% | 140.0% |
| 75-79 | 82.0% | 81.5% | 89.5% | 94.0% | 112.0% | 145.0% |
| 80-84 | 80.5% | 80.0% | 89.0% | 94.0% | 113.0% | 150.0% |
| >=85 | 80.0% | 78.0% | 86.0% | 93.0% | 114.0% | 165.0% |

As an example, using the above calculation rules, an initial risk variable of 10% may be converted into a risk factor of 91.5.0% for the age group of 55-59 year olds. Furthermore, although an example of the calculation rules is discussed above, any other suitable calculation rules may be utilized. For example, the calculation rules may be based on one or more mortality tables, one or more groups, one or more initial risk variables, one or more historical aspects associated with the groups, one or more adjustments and estimations by issuer 18 and/or pension plan 22, any other suitable factor, or any combination of the preceding.

Third, a group premium amount may be determined for each of the groups of participants 34. The group premium amount may be determined in any suitable manner. For example, the group premium amount may be determined based on the risk factor for the group (determined above) and the second premium amounts for each of the participants 34 in the group that have elected to not receive the liability payout 52. For example, as is disclosed above, there may be 1,000 participants in the 55-59 age group, and 900 of these participants 34 may have elected to not receive the liability payout 52. As such, the second premium amount for each of those 900 participants 34 may be summed together, and this resulting sum may be multiplied by the risk factor for the group in order to determine the group premium amount.

Fourth, the second total premium amount may be determined by summing (1) each of the group premium amounts and also (2) the first premium amounts for each of participants (determined in step 225). Once the second total premium amount is determined, the method 200 may move to step 255.

At step 255, the second total premium amount is communicated for display. Such a display of the second total premium amount may allow pension plan 22 to understand the total cost for the annuity generation 26. As such, pension plan 22 may be able to pay issuer 18 this second total premium amount, and the annuity generation 26 may occur. In addition to communicating for display the second total premium amount, other information utilized in method 200 may also be communicated for display. As examples, the group premium amount for one or more of the groups may be communicated for display, the risk factor for one or more of the groups may be communicated for display, the second premium amounts for each of the participants 34 in the group that elected to not receive the liability payout 52 may be communicated for display, any other information may be communicated for display, or any combination of the preceding. Once the second total premium amount is communicated for display, the method may move to step 260, where the method ends.

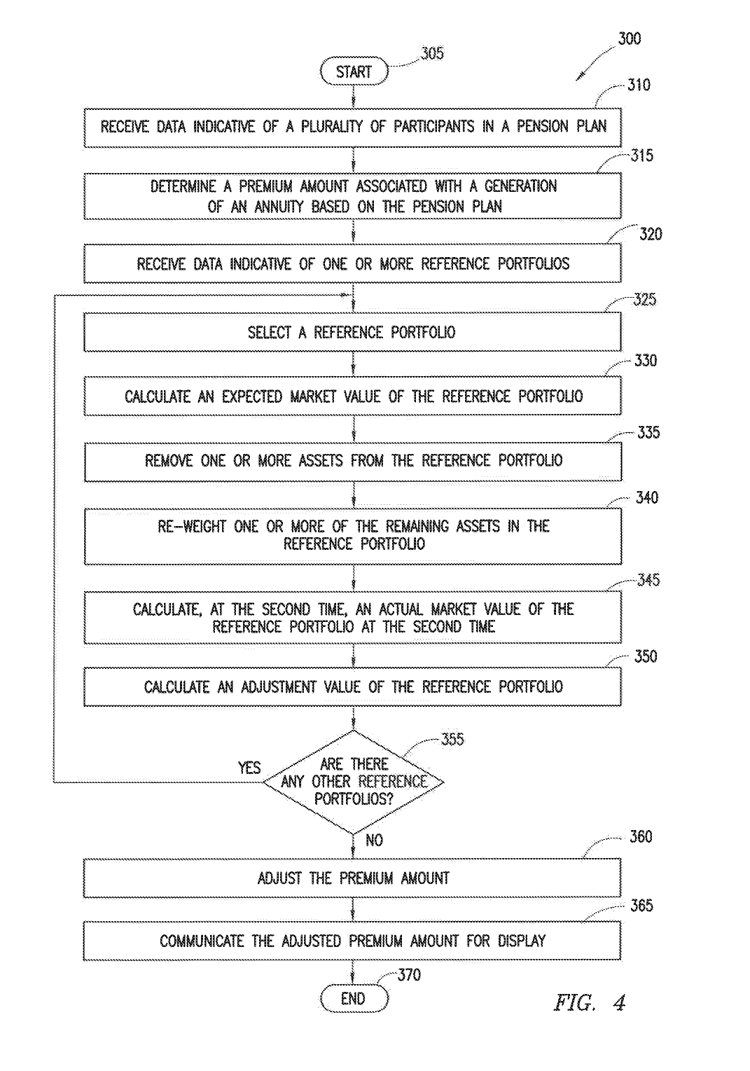

Although FIG. 3 illustrates method 200 as ending at step 260, in particular embodiments, the method may not end. For example, instead of method 200 ending, each of steps 245-255 of method 200 may be repeated any suitable number of times. In such an example, if additional information regarding benefits 38 and the number of benefits 38 that will be included in annuity 30 when annuity generation 26 occurs (e.g., such as an additional participant 34 electing to accept the liability payout 52), the second total premium amount may be re-calculated. As another example, instead of method 200 ending, the method may move to one or more methods of FIGS. 4-6. As such, the second total premium amount (or even the first total premium amount) may be further adjusted prior to the annuity generation 26 and the payment of premium 46 occurring. Additionally, the second total premium amount (or even the first total premium amount) may be used to calculate amounts of the premium that may be allocated to a general account and/or a separate account.

Modifications, additions, or omissions may be made to method 200. Additionally, one or more steps in method 200 of FIG. 3 may be performed in parallel or in any suitable order. For example, steps 220 and 225 of method 200 may be performed in parallel.

As is disclosed above with regard to FIGS. 1A-1B, annuity generation 26 may be based on an agreement that is signed at a first time point 64, but the annuity generation 26 and the payment of premium 46 may not occur until the closing date at the second time point 68. Such a gap in time may create various problems. As an example, when the payment of premium 46 is made using assets 42, the value of the assets 42 may fluctuate in-between the first time point 64 and the second time point 68 (e.g., market-based fluctuations). In order to compensate for such fluctuation, issuer 18 may adjust the amount of premium charged by issuer 18 for the annuity generation 26.

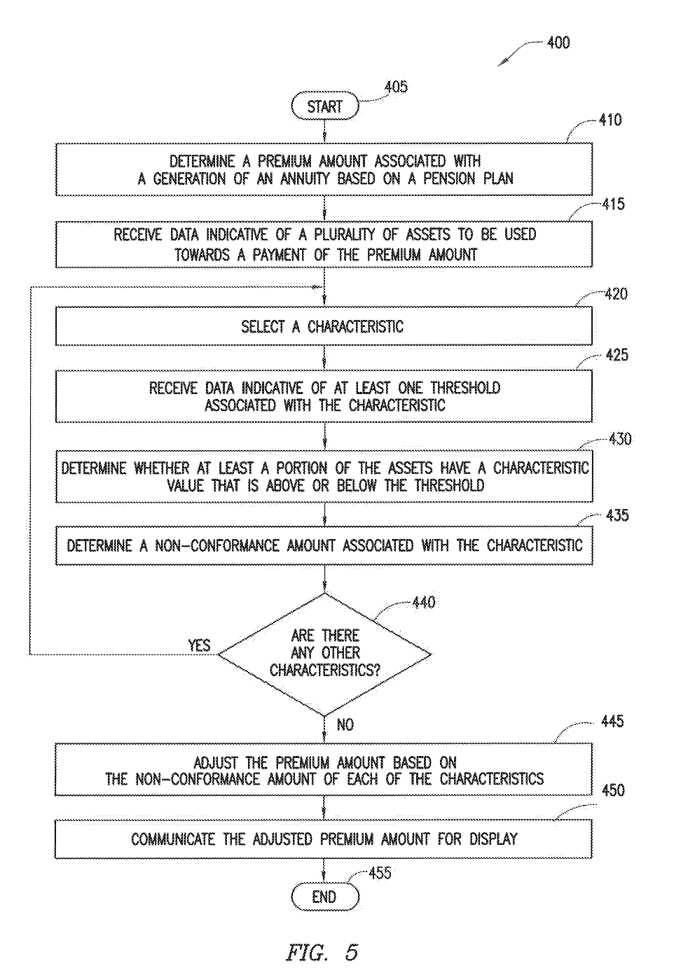

FIG. 4 illustrates a method 300 for adjusting premium amounts associated with a generation of an annuity based on a pension plan according to one embodiment of the present disclosure. One or more steps of method 300 may be performed by calculation device 114 of FIG. 2. Furthermore, one or more steps of method 300 may be performed after, before, or in parallel with one or more steps of method 200 of FIG. 3, method 400 of FIG. 5, method 500 of FIG. 6, any other method, or any combination of the preceding.

The method begins at step 305. At step 310, data indicative of a plurality of participants 34 in a pension plan 22 is received. The data indicative of the plurality of participants 34 may include any type of information associated with one or more participants 34. For example, the data may include an identifier of a participant 34 (such as the name of the participant 34 or an identification number associated with the participant 34), the age of the participant 34, the gender of the participant 34, one or more benefits 38 associated with the participant 34, whether or not the participant 34 is eligible for a liability payout 52, any other suitable information associated with the participant 34, or any combination of the preceding. The data indicative of the plurality of participants 34 may be received in any suitable manner. As an example, the data may be manually input into calculation device 114 of FIG. 2 by a user or an administrator. As another example, the data may be downloaded (or otherwise communicated) from a data source 158 of FIG. 2. The data indicative of a plurality of participants 34 may include information for any suitable number of participants 34 in the pension plan 22. For example, the received data may include information for each of the participants 34 in the pension plan 22 or only a portion of the participants 34 in the pension plan 22. In such an example, the data may include information for two participants 34, 100 participants 34, 1,000 participants 34, 10,000 participants 34, 100,000 participants 34, 1 million participants 34, or any other suitable number of participants 34.

At step 315, a premium amount associated with the generation of an annuity 30 based on a pension plan 22 is determined. The premium amount may be any suitable amount associated with the generation of an annuity 30 based on a pension plan 22. For example, the premium amount may be the same amount as the first total premium amount determined in step 235 of method 200 of FIG. 3. In such an example, after the first total premium amount is determined at step 235 of method 200 of FIG. 3, the first total premium amount may be utilized as the premium amount for step 315 of method 300 of FIG. 4. By utilizing the first total premium amount from FIG. 3 (which may be the preliminary premium amount disclosed above with regard to FIGS. 1A-1B), pension plan 22 and issuer 18 may both be able to understand how the final premium (i.e., the final premium amount that will be paid by pension plan 22 to issuer 18 when the annuity generation 26 occurs at second time point 68) will be adjusted for changes that occur in-between the first time point 64 and the second time point 68 of FIG. 1B. As another example, the premium amount may be the same amount as the second total premium amount determined in step 250 of method 200 of FIG. 3. In such an example, after the second total premium amount is determined at step 250 of method 200 of FIG. 2, the second total premium amount may be utilized as the premium amount for step 315 of method 300 of FIG. 4. As such, method 300 may adjust the second total premium amount from method 200 of FIG. 3. By utilizing the second total premium amount from FIG. 3 (which may be the final premium amount disclosed above with regard to FIGS. 1A-1B), the final premium amount may be adjusted for changes that may occur in-between the first time point 64 and the second time point 68 of FIG. 1B.

The premium amount associated with the generation of an annuity 30 based on a pension plan 22 may determined in any suitable manner. For example, the premium amount may be received at calculation device 114 based on an input from a user and/or administrator. In such an example, the user may determine the premium amount in any suitable manner and input it into calculation device 114. As another example, the premium amount may be calculated by calculation device 114. In such an example, calculation device 114 may perform one or more steps of method 200 of FIG. 3, or calculation device 114 may calculate the premium amount in any other suitable manner.

At step 320, data indicative of one or more reference portfolios is received. A reference portfolio may represent any suitable grouping of assets. For example, a reference portfolio may include a grouping of one or more real properties, cash, stocks, bonds, treasuries, private equities, intangible assets, tangible assets, any other suitable type of asset, or any combination of the preceding. The reference portfolio may not be a real portfolio of assets actually owned by pension plan 22 or issuer 18. Instead, it may include an example grouping of assets that issuer 18 may be willing to accept from pension plan 22 as the payment of premium 26. For example, the reference portfolio may have one or more durations (such as one or more key rate durations) that issuer 18 may be willing to accept from pension plan 22 as the payment of premium 26. In such an example, the reference portfolio may be created (such as by issuer 18) to have the particular one or more durations.

The reference portfolio may correspond to a liability associated with the annuity 30. For example, as is disclosed above in FIGS. 1A-1B, annuity generation 26 may result in issuer 38 being liable for one or more benefits 38. This liability may be measured as the cash flow needed to pay the benefits 38 as they come due in the annuity 30. For example, the monthly cash flow needed to pay for $10 billion in benefits 38 may be, for example, $10 million per month for 45 years. In such an example, the reference portfolio may correspond to this cash flow of $10 million per month for 45 years. In particular, the reference portfolio may have a duration (such as a key rate duration) that will provide this cash flow of $10 million per month for 45 years.

The reference portfolio may correspond to a actual liability associated with the annuity 30, or one or more predicted liabilities associated with the annuity 30. For example, the reference portfolio may correspond to the actual liability of the annuity 30 when the actual liability associated with the annuity 30 is already known or can be calculated. Such an example may occur when issuer 18 already knows which participants 34 and which benefits 38 will be included in the annuity 30. As another example, the reference portfolio may correspond to a predicted liability associated with annuity 30 when the liability associated with annuity 30 is unknown or cannot yet be calculated. Such an example may occur when issuer 18 is uncertain of which participants 34 and benefits 38 may be included in annuity 30. In order to compensate for the risk caused by this uncertainty, issuer 18 may create two or more reference portfolios that may each correspond to a particular predicted liability of annuity 30. These predicted liabilities may represent goalposts for the liability associated with annuity 30. For example, when two reference portfolios are created, the first reference portfolio may correspond to a predicted liability that may not require a high cash flow in the near future (such as when the average participant 34 of annuity 30 is predicted to be 50-years old, with average health, and a benefit 38 of $100,000), and the second reference portfolio may correspond to a predicted liability that may require a high cash flow soon (such as when the average participant 34 of annuity 30 is predicted to be 65-years old, with good health, and a benefit 38 of $300,000). Furthermore, the two predicted liabilities may have a range in-between them that will eventually include the actual liability. For example, the first predicted liability may be a cash flow of $6 million per month for thirty years, the second predicted liability may be a cash flow of $15 million per month for 60 years, and the actual liability may be a cash flow of $10 million per month for 45 years (which is in-between the two predicted liabilities).

The data indicative of the reference portfolios may include any type of information associated with the reference portfolios. For example, the data may include an identifier of each of the assets in the reference portfolio (such as the name of the asset or an identification number associated with the asset), one or more ratings of each asset (such as AAA, AA+, AA, AA−, A+, A, A−, BBB+, BBB, etc.), an identifier of each type of asset, a number of each asset (such as 1 share of a particular stock, 2 shares of a particular stock, etc.), a current value of each asset, any other suitable information, or any combination of the preceding. The data indicative of the one or more reference portfolios may include information for any suitable number of reference portfolios. For example, the data may include information for one reference portfolio, two reference portfolios, three reference portfolios, four reference portfolios, ten reference portfolios, twenty reference portfolios, or any other suitable number of reference portfolios. The data indicative of one or more reference portfolios may be received in any suitable manner. As an example, the data may be manually input into calculation device 114 of FIG. 2 by a user or an administrator. As another example, the data may be downloaded (or otherwise communicated) from a data source 158 of FIG. 2 (such as Moody's Investors Service, Barclays Investment Bank, Standard & Poor's, etc.).

At step 325, a reference portfolio is selected. Any of the reference portfolios may be selected, and the reference portfolios may be selected in any suitable manner. Once the reference portfolio is selected at step 325, one or more steps of method 300 (such as steps 330-350 of method 300) may be performed for that particular selected reference portfolio.

At step 330, an expected market value of the reference portfolio is calculated. The expected market value may represent a value the reference portfolio is expected to have at a future time. The expected market value may be calculated at a first time (such as sometime before the second time point 68 of FIG. 1B), but may be the expected market value of the reference portfolio at a second time (such as the expected market value of the reference portfolio at the second time point 68 of FIG. 1B). For example, the expected market value of a reference portfolio on Dec. 15, 2015 may be calculated on Jun. 15, 2015 using the market conditions on Jun. 15, 2015. The expected market value of the reference portfolio may be calculated in any suitable manner. For example, the expected market value of each asset of the reference portfolio (such as the expected market value of 5,000 bonds) may be determined (such as received from a data source 158 of FIG. 2), and each of these expected market values may be summed together to calculate the expected market value of the reference portfolio. In such an example, if the reference portfolio includes 5,000 bonds, the expected market value of the reference portfolio may be the sum of the expected market value of each of the 5,000 bonds.

At step 335, one or more assets are removed from the reference portfolio. The removal of assets from the reference portfolio may allow the premium amount to be adjusted (at step 360) based on a reference portfolio that only includes a type of assets that would be desirable to issuer 18 (such as a type of assets that have at least a particular credit rating or that have at least a particular performance). The assets may be removed from the reference portfolio based on one or more rules. The rules may be determined by issuer 18, and may include any suitable rules that may be utilized for removing the assets from reference portfolio. As an example, an asset may be removed if the credit rating for the asset is downgraded. In such an example, if one or more rating agencies downgrade a credit rating associated with the asset (such as if two rating agencies downgrade the credit rating of a particular bond from a AAA rating to a BBB+ rating), the asset may be removed from the reference portfolio. As another example, an asset may be removed if the asset is performing under a threshold.

At step 340, one or more of the remaining assets in reference portfolio are re-weighted. The remaining assets in reference portfolio may be re-weighted using a value associated with the removed assets. For example, if a particular type of bond is removed from the reference portfolio, the value of that bond type (such as $4,500 when there are 300 bonds of that type at a price of $15 per bond) may be utilized to re-weight the remaining assets. In such an example, the $4,500 value may be utilized to accrue more bonds of the type that are remaining in the reference portfolio. In particular, if the reference portfolio includes 1,000 bonds of a particular type (such as bond “A”), and each of those bonds have a current price of $45, the $4,500 value from the removed assets may be used to add 100 more “A” bonds (for a total of 1,100 “A” bonds). The remaining assets in the reference portfolio may be re-weighted in any suitable manner. For example, the value associated with the removed assets may be distributed evenly over the remaining assets, may be distributed to only the top rated asset, may be distributed in a pro-rata format based on credit rating, any other suitable distribution, or any combination of the preceding.

At step 345, an actual market value of the reference portfolio at the second time is calculated. The actual market value may represent the actual value of the reference portfolio at the second time. As an example, if on Dec. 15, 2015, a reference portfolio includes 1,000 bonds with an actual price of $25 per bond, the actual market value on Dec. 15, 2015 may be calculated to be $25,000. Furthermore, as is disclosed above, because one or more assets have been removed from the reference portfolio, the actual market value of the reference portfolio may represent the actual market value of only the remaining assets (after re-weighting) in the reference portfolio. The actual market value of the reference portfolio may be calculated in any suitable manner. For example, the actual market value of each asset of the reference portfolio (such as the actual market value of 1,000 bonds) may be determined (such as received from a data source 158 of FIG. 2), and each of these actual market values may be summed together to calculate the actual market value of the reference portfolio.

At step 350, an adjustment value of (or otherwise attributable to) the reference portfolio is calculated. An adjustment value may represent the change in value between the expected market value of the reference portfolio at the second time and the actual market value of the reference portfolio at the second time. For example, if the expected market value of the reference portfolio on Dec. 15, 2015 was calculated to be $23,000 and the actual market value of the reference portfolio on Dec. 15, 2015 is calculated to be $25,000, the adjustment value of the reference portfolio may be 1.087 (25,000/23,000=1.087). As another example, if the expected market value of the reference portfolio on Dec. 15, 2015 was calculated to be $30,000 and the actual market value of the reference portfolio on Dec. 15, 2015 is calculated to be $30,330, the adjustment value of the reference portfolio may be 1.011 (30,330/30,000=1.011).

At step 355, it is determined whether there are any other reference portfolios for which an adjustment value has not been calculated. If there are additional reference portfolios, method 200 may move back to step 325 where a reference portfolio is selected. As such, steps 325-350 of method 300 may be repeated for each reference portfolio. On the other hand, if there are not any other reference portfolios, the method 300 may move to step 360.

At step 360, the premium amount is adjusted. The premium amount may be adjusted based at least in part on the adjustment value of each of the reference portfolios. For example, if there are two reference portfolios, the premium amount may be adjusted based on the adjustment value of these two reference portfolios. The premium amount may be adjusted in any suitable manner. An example of the adjustment of the premium amount based on the adjustment value of two reference portfolios is disclosed below.

First, data indicative of the actual liability associated with the annuity 30 is received. For example, once issuer 18 is made aware of which participants 34 and which benefits 38 will be included in the annuity 30 (e.g., such as at (or before) the second time point 68 of FIG. 1B), issuer 18 may determine the actual liability associated with paying for each of the benefits 38 of annuity 30 as they come due. The actual liability may be determined in any suitable manner. For example, based on which benefits 38 are included in annuity 30, issuer 18 may determine an amount of cash flow that may be used to pay for such benefits 38 as they come due (such as $10 million per month for 45 years). Furthermore, based on this determined cash flow, issuer 18 may determine one or more durations (such as one or more bond durations) that may correspond to this cash flow (such as 7.5). This cash flow of the actual liability and the duration that may correspond to this cash flow may be determined in any suitable manner. The data indicative of the actual liability associated with the annuity 30 may include any information that indicates the actual liability For example, the information may include an identifier of a duration (such as an identifier of a duration of 7.5) that corresponds to the actual liability, an identifier of the actual liability that can be used to determine the duration, any other suitable information, or any combination of the preceding.

Second, a first percentage associated with the first reference portfolio and a second percentage associated with the second reference portfolio is calculated. The first percentage and the second percentage may be calculated based on the actual liability and the first and second predicted liabilities. For example, as is disclosed above, the actual liability may be in-between the first predicted liability and the second predicted liability. In such an example, the first predicted liability may correspond to a duration of 5, the second predicted liability may correspond to a duration of 10, and the actual liability may correspond to a duration of 7.5 (which is in-between 5 and 10). As such, the first percentage associated with the first reference portfolio and the second percentage associated with the second reference portfolio may represent the percentages that the first reference portfolio and the second reference portfolio may be multiplied by in order to create a reference portfolio with a duration equal to the duration of the actual liability (e.g., 7.5). As an example, in order to create a preliminary reference portfolio with a duration of 7.5, the first reference portfolio (e.g., with a duration of 5) may be multiplied by 50 percent and the second reference portfolio (e.g., with a duration of 10) may be multiplied by 50 percent ((5*50%)+(10*50%)=7.5) Thus, in such an example, the first percentage associated with the first reference portfolio may be 50 percent and the second percentage associated with the second reference portfolio may also be 50 percent.

Third, an adjustment variable is calculated. The adjustment variable may be calculated based on the first percentage, the second percentage, and the adjustment value of the first and second reference portfolios (calculated above at step 350). For example, the adjustment variable may be calculated to be 1.05 when the first reference portfolio has an adjustment value of 1.087 (calculated above at step 350) and a first percentage of 50%, and when the second reference portfolio has an adjustment value of 1.011 (calculated above at step 350) and a second percentage of 50% ((1.087*50%)+(1.011*50%)=1.05).

Fourth, the premium amount is multiplied by the adjustment variable. By multiplying the premium amount by the adjustment variable, the adjusted premium amount may be calculated. For example, when the premium amount is $10 billion and the adjustment variable is 1.05, the adjusted premium amount may be calculated to be $10.50 billion. That is, the premium amount of $10 billion may be increased by $500 million. Such an adjustment may allow the premium amount to be adjusted (e.g., for the fluctuation in the market) for the time period in-between when the agreement was signed between the pension plan 22 and the issuer 18 (e.g., the first time point 64 of FIG. 1B) and the closing date of the agreement between the pension plan 22 and the issuer 18 (e.g., the second time point 68).

At step 365, the adjusted premium amount is communicated for display. Such a display of the adjusted premium may allow pension plan 22 to understand the total cost for the annuity generation 26, when adjusted (e.g., for the fluctuation in the market) for the time period in-between when the agreement was signed between the pension plan 22 and the issuer 18 (e.g., the first time point 64 of FIG. 1B) and the closing date of the agreement between the pension plan 22 and the issuer 18 (e.g., the second time point 68). For example, when the premium amount of FIG. 4 is the same amount as the first total premium amount determined in step 235 of method 200 of FIG. 3, the adjustment of this premium amount may allow pension plan 22 and issuer 18 to both be able to understand how the final premium (i.e., the final premium amount that will be paid by pension plan 22 to issuer 18 when the annuity generation 26 occurs at second time point 68) will be adjusted for changes (e.g., market-based changes) that occur in-between the first time point 64 and the second time point 68 of FIG. 1B. As such, both pension plan 22 and the issuer 18 may be able to sign the agreement at the first time point 64, but still understand how the final cost of the closing of the agreement will be calculated at the second time point 64. As another example, when the premium amount of FIG. 4 is the same amount as the second total premium amount determined in step 250 of method 200 of FIG. 3, the adjustment of this premium amount may allow pension plan 22 and issuer 18 to view the final premium for the annuity generation 26 when adjusted for changes (e.g., market-based changes) that occurred in-between the first time point 64 and the second time point 68 of FIG. 1B. As such, pension plan 22 can provide the correct payment of premium 46 to issuer 18, and the annuity generation 26 can occur (resulting in a transfer of risk associated with benefits 38 from pension plan 22 to issuer 18). Once the adjusted premium is communicated for display, the method may move to step 370, where the method ends.

Although FIG. 4 illustrates method 300 as ending at step 370, in particular embodiments, the method may not end. For example, instead of method 300 ending, each of steps 320-365 of method 300 may be repeated any suitable number of times. In such an example, if additional information regarding benefits 38 and the number of benefits 38 included in the annuity 30 is received (e.g., such as an additional participant 34 electing to accept the liability payout 52), the premium amount may be re-adjusted. As another example, instead of method 300 ending, the method may move to one or more methods of FIGS. 5-6. As such, the adjusted premium may be further adjusted prior to the annuity generation 26 and the payment of premium 46 occurring. Additionally, the adjusted premium may be used to calculate amounts of the premium that may be allocated to a general account and/or a separate account.

Modifications, additions, or omissions may be made to method 300. For example, steps 325 (where a reference portfolio is selected) and 355 (where it is determined whether there are any other reference portfolios) may be performed at various different points in method 300. In such an example, this may allow steps 330-340 to be performed for each reference portfolio prior to the second time, and then allow steps 345-350 to be performed for each reference portfolio when the second time actually occurs. Additionally, one or more steps in method 300 of FIG. 4 may be performed in parallel or in any suitable order. For example, one or more (or each) of steps 325-350 of FIG. 4 may be performed for two or more (or each) of the reference portfolios in parallel.

As is disclosed above, the payment of premium 46 provided to issuer 18 for the annuity generation 26 may include a transfer of assets 42 from pension plan 22 to issuer 18. The amount of assets 42 transferred to issuer (i.e., the premium amount), however, may depend on the type of assets 42 that are being transferred to issuer 18. For example, if all of the assets 42 transferred to issuer 18 are of a type that is desirable by issuer 18, the premium amount for the annuity generation 26 may be lower than if some (or all) of the assets 42 are of a type that is undesirable to issuer 18. In order to help ensure that that assets 42 are of a type that is desirable to issuer 18, pension plan 22 and issuer 18 may have come to an agreement (e.g., signed an agreement at the first time point 64) that defines (or otherwise establishes) one or more characteristics of the assets 42 that will be transferred to issuer 18 as the payment of premium 46 (e.g., at the second time point 68). Such a signed agreement (disclosed in FIG. 1B) at the first time point 64 may allow pension plan 22 the time in-between the first time point 64 and the second time point 68 to acquire a grouping of assets (such as an asset portfolio) that meets the one or more characteristics agreed to by pension plan 22 and issuer 18 at the first time point 64.

Unfortunately, for various reasons (e.g., market fluctuations, etc.), pension plan 22 may be unable to obtain (and transfer to issuer 18) assets 42 that meet the one or more characteristics previously agreed upon. As such, in order to compensate for any differences in-between the assets 42 provided by pension plan 22 and the one or more characteristics agreed to by pension plan 22 and issuer 18, the premium amount may be adjusted. Such an adjustment may allow the annuity generation 26 to occur even when the assets 42 provided by pension plan 22 do not meet one or more characteristics previously agreed to by pension plan 22 and issuer 18.

FIG. 5 illustrates a method 400 for adjusting premium amounts associated with a generation of an annuity based on a pension plan using one or more characteristics of the assets received according to one embodiment of the present disclosure. One or more steps of method 400 may be performed by calculation device 114 of FIG. 2. Furthermore, one or more steps of method 400 may be performed after, before, or in parallel with one or more steps of method 200 of FIG. 3, method 300 of FIG. 4, method 500 of FIG. 6, any other method, or any combination of the preceding.

The method begins at step 405. At step 410, a premium amount associated with the generation of an annuity 30 based on an pension plan 22 is determined. The premium amount may be any suitable amount associated with the generation of the annuity 30 based on the pension plan 22. For example, the premium amount may be the same amount as the first total premium amount determined in step 235 of method 200 of FIG. 3. In such an example, after the first total premium amount is determined at step 235 of method 200 of FIG. 3, the first total premium amount may be utilized as the premium amount for step 410 of method 400 of FIG. 5. By utilizing the first total premium amount from FIG. 3 (which may be the preliminary premium amount disclosed above with regard to FIGS. 1A-1B), pension plan 22 and issuer 18 may both be able to understand how the final premium will be adjusted for assets 42 that do not meet one or more characteristics, even though one or more variables regarding the annuity generation 26 may be unknown at the time. As another example, the premium amount may be the same amount as the second total premium amount determined in step 250 of method 200 of FIG. 3. In such an example, after the second total premium amount is determined at step 250 of method 200 of FIG. 2, the second total premium amount may be utilized as the premium amount for step 410 of method 400 of FIG. 5. By utilizing the second total premium amount from FIG. 3 (which may be the final premium amount disclosed above with regard to FIGS. 1A-1B), pension plan 22 and issuer 18 may be able to understand how that final premium will actually be adjusted for the assets 42 that are transferred to issuer 18. As another example, the premium amount may include the adjusted premium amount from FIG. 4. By utilizing the adjusted premium amount from FIG. 4, pension plan 22 and issuer 18 may be able to understand how the adjusted premium amounts will be further adjusted based on the assets 42 transferred to issuer 18.

At step 415, data indicative of a plurality of assets 42 to be used towards a payment of the premium amount 46 is received. The data indicative of the plurality of assets 42 may include any type of information associated with the assets 42. For example, the data may include an identifier of each of the assets (such as the name of the asset or an identification number associated with the asset), one or more ratings of each asset (such as AAA, AA+, AA, AA−, A+, A, A−, BBB+, BBB, etc.), an identifier of each type of asset, a number of each asset (such as 1 share of a particular stock, 2 shares of a particular stock, etc.), a current value of each asset, any other suitable information, or any combination of the preceding. The data indicative of the plurality of assets 42 may be received in any suitable manner. As an example, the data may be manually input into calculation device 114 of FIG. 2 by a user or an administrator. As another example, the data may be downloaded (or otherwise communicated) from a data source 158 of FIG. 2 (such as Moody's Investors Service, Barclays Investment Bank, Standard & Poor's, etc.).

At step 420, a characteristic is selected. A characteristic may represent any characteristic associated with one or more assets 42 that may be transferred to issuer 18 as the payment of the premium 46. As examples, a characteristic may include a single issuer limit, an aggregate credit rating quality limit, an asset class limit, a reinvestment asset limit, a key rate duration, a sector limit, a country limit, a technical breach adjustment, any other characteristic that may be associated with one or more assets 42, or any combination of the preceding. Furthermore, a characteristic associated with an asset 48 may include a characteristic that may not be inherently associated with an asset 48. For example, an asset 42 (e.g., a bond) may not be inherently associated with a single issuer limit. However, pension plan 22 and issuer 18 may have agreed to associate a single issuer limit, for example, with an asset 42. Any of the characteristics may be selected, and the characteristic may be selected in any suitable manner. Once the characteristic is selected at step 420, one or more steps of method 400 (such as steps 425-435 of method 400) may be performed for that particular characteristic.

At step 425, data indicative of at least one threshold associated with the characteristic is received. A threshold may represent a minimum amount, a maximum amount, or a target amount associated with a particular characteristic. For example, if the characteristic is a single issuer limit, the threshold associated with that characteristic may include a maximum amount (and/or percentage) of single issuer assets in the assets 42 that may be acceptable to issuer 18 as the payment of premium 46. The data indicative of the at least one threshold may include any type of information associated with the threshold. For example, the data may include an identifier of the characteristic, an identifier of a threshold type (e.g., maximum, minimum, target), a threshold amount, any other information associated with the threshold, or any combination of the preceding. The data indicative of the at least one threshold may be received in any suitable manner. As an example, the data may be manually input into calculation device 114 of FIG. 2 by a user or an administrator. As another example, the data may be downloaded (or otherwise communicated) from a data source 158 of FIG. 2.

At step 430, it is determined whether at least a portion of the assets 42 have a characteristic value that is above or below the threshold. The portion of the assets 42 may include any suitable amount of the assets 42. For example, the portion of the assets 42 may include all of the assets 42 or less than all of the assets 42. Furthermore, the portion of the assets 42 may be determined in any suitable manner. For example, the portion of the assets 42 may be determined based on a number of assets 42 that are related to the characteristic (e.g., if a characteristic includes bond types, the portion of the assets 42 may include only the assets in assets 42 that are bonds).

The characteristic value may represent a value of the assets 42 that is associated with the characteristic. For example, if the characteristic is a single issuer limit, and the threshold associated with the single issuer limit is that only 1% of the assets 42 may be issued by a single company with a particular rating (e.g., such as General Electric, which may have a credit rating of AAA), the characteristic value of the portion of the assets 42 may be the percentage of assets in assets 42 that are issued by General Electric (e.g., 2%). The characteristic value may be determined in any suitable manner. For example, the characteristic value may be received at calculation device 114 based on an input from a user and/or administrator. As another example, the characteristic value may be calculated by calculation device 114. In such an example, the calculation device 114 may utilize the data indicative of the plurality of assets 42 in order to calculate the characteristic value (e.g., calculate that assets issued by General Electric are 2% of the assets 42).

The determination of whether at least the portion of the assets 42 have a characteristic value that is above or below the threshold may be made based on the threshold associated with the characteristic, and the characteristic value. For example, if a threshold for single issuer assets issued by, for example, General Electric (with a credit rating of AAA) is 1%, and the portion of the assets 42 includes 2% of single issuer assets issued by General Electric, it may be determined that the portion of the assets 42 have a characteristic value that is above the threshold. On the other hand, if a threshold for single issuer assets issued by, for example, General Electric (with a credit rating of AAA) is 1%, and the portion of the assets 42 includes 0.5% of single issuer assets issued by General Electric, it may be determined that the portion of the assets 42 have a characteristic value that is below the threshold

At step 435, a non-conformance amount associated with the characteristic is determined. The non-conformance amount may represent an amount by which the premium amount may be adjusted. For example, if the portion of assets 42 did not meet the single issuer limit for General Electric, the non-conformance amount may represent the amount that the premium amount is adjusted to compensate issuer 18 for assets 42 not being below the 1% threshold for General Electric. The non-conformance amount may be determined in any suitable manner. As an example, if pension plan 22 provided assets 42 that included more than 1% of single issuer assets issued by, for example, General Electric, a non-conformance factor (such as, for example, 2.4%) may be applied to the percentage of single issuer assets from General Electric above the 1.0% threshold. In such an example, if the premium amount was $10 billion, but the assets 42 included $200 million worth of single issuer assets from General Electric (which is 2% of the assets 42), the additional $100 million of those single issuer assets above the threshold may be multiplied by the non-conformance factor of 2.4% in order to calculate a non-conformance amount for that set of single issuer assets of $2.4 million dollars. On the other hand, if the assets 42 provided by pension plan 22 only included $100 million of single issuer assets from General Electric (which is 1% of the assets 42), the non-conformance amount calculated for those single issuer assets may be $0 (e.g., the 1% characteristic value was not above the 1% threshold, and therefore there the non-conformance amount is $0). Furthermore, the non-conformance amount associated with the characteristic may further include all of the non-conformance amounts associated with that characteristic. For example, if assets 42 include single issuer assets issued by five different companies and the non-conformance amount for each of those companies is $2.4 million a piece, the non-conformance amount associated with the characteristic may be equal to $12 million ($2.4 million*5=$12 million).

At step 440, it is determined whether there are any other characteristics for which a non-conformance amount has not been calculated. If there are additional characteristics, method 400 may move back to step 420 where a characteristic is selected. As such, steps 425-435 of method 400 may be repeated for each characteristic. On the other hand, if there are not any other characteristics, the method 400 may move to step 445.

At step 445, the premium amount is adjusted based on the non-conformance amount of each of the characteristics. The premium amount may be adjusted in any suitable manner based on the non-conformance amount of each of the characteristics. For example, the non-conformance amount for each of the characteristics may be added together (e.g., summing the non-conformance amount for each of one or more of the single issuer limit characteristic, the aggregate credit rating quality limit characteristic, the asset class limit characteristic, the reinvestment asset limit characteristic, the key rate duration characteristic, the sector limit characteristic, the country limit characteristic, the technical breach adjustment characteristic, any other characteristic), and the total non-conformance amount for all of those characteristics may be added to the premium amount. In such an example, if the premium amount was $10 billion and the non-conformance amount for all of the characteristic is $500 million, the premium amount may be adjusted to $10.5 billion.

At step 450, the adjusted premium amount is communicated for display. Such a display of the adjusted premium amount may allow pension plan 22 and issuer 18 to both understand the total cost for the annuity generation 26, when adjusted for the assets 42 that may not (or may) meet the one or more characteristic previously agreed to. As such, pension plan 22 may provide the correct payment of premium 46 to issuer 18, and annuity generation 26 may occur (resulting in issuer 18 being liable for benefits 38 in annuity 30). Once the adjusted premium is communicated for display, the method may move to step 455, where the method ends.

Although FIG. 5 illustrates method 400 as ending at step 455, in particular embodiments, the method may not end. As an example, instead of method 400 ending, the method may move to one or more methods of FIGS. 3-4 and 6. Additionally, method 400 may also include additional steps. For example, in order to prevent double billing for certain characteristics, an asset 42 that has a characteristic that is above or below a threshold for that characteristic may not be part of a subset used to calculate a non-conformance amount associated with another characteristic. In such an example, if a single issuer (e.g., General Electric) issued more than 1% of the assets 42 (when the single issuer threshold is 1%), the General Electric issued assets that are over the 1% single issuer threshold may be removed from any further adjustment calculations. Therefore, the General Electric issued assets that are over the 1% single issuer threshold may not be part of the second subset of at least a portion of assets 42 that are used with regard to the aggregate credit rating quality limit characteristic. Accordingly, one or more of the subsets (e.g., the first subset, the second subset, the third subset, etc.) may be different. On the other hand, one or more of the subsets (e.g., the first subset, the second subset, the third subset, etc.) may be the same. For example, an asset 42 that has a characteristic that is above or below a threshold for that characteristic may still be included in a subset used to calculate a non-conformance amount associated with another characteristic.

Furthermore, although a particular example of steps 425-435 was disclosed above, steps 425-435 may be performed in any other suitable manner. For example, the manner of performing steps 425-435 may be different (or the same) based on the selected characteristic. Examples of the performance of steps 425-435 based on particular characteristics are disclosed below in further detail.

As a first example, when the characteristic is a single issuer limit, steps 425-435 of FIG. 5 may be performed in a manner that may be different from (or the same as) that disclosed above. A single issuer limit may represent a limit on the number of assets in assets 42 that were issued by a single company (e.g., bonds issued by General Electric). An example of the performance of steps 425-435 of FIG. 5 when the characteristic is a single issuer limit is disclosed below.

First, data indicative of at least one threshold associated with a single issuer limit is received. Such data may include information for any suitable threshold (or thresholds) associated with a single issuer limit. As an example, the information may include a credit rating (e.g., AAA), a threshold associated with that credit rating (e.g., 5.0%), a non-conformance factor for exceeding that threshold for that credit rating (e.g., 5.0%), any other information, or any combination of the preceding. Furthermore, the data may include such information for any suitable number of credit ratings. An example of this data is disclosed below:

| | | Non-conformance |
|---|---|---|
| Credit Rating | Threshold | Factor |
| GOV | NA | 0.00% |
| AAA | 5.00% | 5.00% |
| AA+ | 5.00% | 5.00% |
| AA | 5.00% | 5.00% |
| AA− | 5.00% | 5.00% |
| A+ | 5.00% | 5.00% |
| A | 5.00% | 5.00% |
| A− | 5.00% | 5.00% |
| BBB+ | 3.75% | 5.75% |
| BBB | 3.75% | 5.75% |
| BBB− | 3.75% | 5.75% |
| BB+ | 1.500% | 7.00% |
| BB | 1.50% | 7.00% |
| BB− | 1.50% | 7.00% |
| B+ | 1.50% | 7.00% |
| B | 1.00% | 8.00% |
| B− | 1.00% | 8.00% |
| CCC+ | 1.00% | 8.00% |
| CCC | 0.50% | 9.00% |
| CCC− | 0.50% | 9.00% |
| CC | 0.50% | 9.00% |
| C | 0.25% | 10.00% |
| D | 0.25% | 10.00% |
| NR | NA | 0.00% |

Although example data is disclosed above, any other suitable information may be included in the data indicative of at least one threshold associated with a single issuer limit. As an example, the data may not include information regarding the non-conformance factor.

Second, a first subset of at least a portion of assets that comprise single issuer assets is determined and each entity that issued one of the assets in the first subset is determined. For example, if assets 42 includes, for example, 500 single issuer assets, those 500 single issuer assets may be determined to be the first subset of the assets 42. Furthermore, for each of those single issuer assets, the entity that issued each single issuer asset may be determined. In such an example, if 400 of the single issuer assets were issued by General Electric, 50 of the single issuer assets were issued by Goldman Sachs, and 50 of the single issuer assets were issued by Boeing, the identity of, for example, General Electric, Goldman Sachs, and Boeing may be determined. These determinations regarding the first subset and each entity that issued one of the assets in the first subset may be determined by calculation device 114 based on the data indicative of a plurality of assets 42. For example, such data may indicate which of the assets 42 are single issuer assets, and may further indicate which entity issued the single issuer asset.

Third, for one of the entities (e.g., General Electric), the value associated with a number of assets in the first subset that were issued by the entity is determined. For example, if the first subset includes 400 assets that were issued by General Electric, and the value of those 400 assets is 6% of the assets 42, the value may be determined to be 6%. Furthermore, that value of 6% may be the characteristic value.

Fourth, for one of the entities (e.g., General Electric), a value associated with a credit rating of the entity is determined. For example, if General Electric has a credit rating of AAA, and the data indicative of the at least one threshold indicates that a single issuer with a credit rating of AAA may issue a maximum of 5% of the assets 42, the value associated with the credit rating of General Electric may be 5%. Furthermore, the value of 5% may be the threshold.

Fifth, the value associated with the number of assets in the subset that were issued by the entity is compared with the value associated with the credit rating of the entity. For example, the 6% characteristic value may be compared with the 5% threshold in order to determine that the 6% characteristic value is above the 5% threshold. On the other hand, if the characteristic value is 5% and the threshold is 5%, the comparison may result in a determination that the characteristic value is not above the threshold.

Sixth, the non-conformance amount associated with the characteristic is determined. For example, if the characteristic value is 6% and the threshold is 5%, a non-conformance factor (such as, for example, 5.0%) may be applied to the 1% of the characteristic value that is above the threshold. In such an example, the non-conformance amount for the General Electric single issuer assets may be $5 million ($10 billion*1%*5%=$5 million). Additionally, the non-conformance amount may further include the non-conformance amounts associated with the single issuer assets issued by the other entities (if any). For example, the non-conformance amount may include the total non-conformance amount for each of the General Electric single issuer assets, the Goldman Sachs single issuer assets, and the Boeing single issuer assets. Furthermore, this determined non-conformance amount may be utilized for the single issuer limit characteristic when the method of FIG. 5 moves to step 445 (disclosed above).

As a second example, when the characteristic is an aggregate credit rating quality limit, steps 425-435 of FIG. 5 may be performed in a manner that may be different from (or the same as) that disclosed above. An aggregate credit rating quality limit may represent a limit on the number of assets in assets 42 that are issued by one or more entities having particular credit ratings. For example, the aggregate credit rating quality limit may indicate that only 60% of the assets in assets 42 may be issued by entities having a credit rating of A+, A, or A−. An example of the performance of steps 425-435 of FIG. 5 when the characteristic is an aggregate credit rating quality limit is disclosed below.

First, data indicative of at least one threshold associated with the aggregate credit rating quality limit is received. Such data may include information for any suitable threshold (or thresholds) associated with an aggregate credit rating quality limit. As an example, the information may include one or more credit ratings (e.g., AAA), one or more groupings associated with the credit ratings (e.g., group 1), a threshold amount for the group (e.g., 10%), a non-conformance factor for exceeding that threshold for the group (e.g., 0.5%), any other information, or any combination of the preceding. Furthermore, the data may include such information for any suitable number of credit ratings and any suitable number of groups. An example of this data is disclosed below:

| Credit | |
|---|---|
| Rating | Group |
| GOV | 0 |
| AAA | 1 |
| AA+ | 1 |
| AA | 1 |
| AA− | 1 |
| A+ | 2 |
| A | 2 |
| A− | 2 |
| BBB+ | 3 |
| BBB | 3 |
| BBB− | 3 |
| BB+ | 4 |
| BB | 4 |
| BB− | 4 |
| B+ | 4 |
| B | 4 |
| B− | 4 |
| CCC+ | 4 |
| CCC | 4 |
| CCC− | 4 |
| CC | 4 |
| C | 4 |
| D | 4 |
| NR | −1 |

| | | Non- |
|---|---|---|
| | | conformance |
| Group | Threshold | Factor |
| −1 | NA | 0.00% |
| 0 | NA | 0.00% |
| 1 | 10.00% | 0.5% |
| 2 | 50.00% | 0.5% |
| 3 | 20.00% | 2.50% |
| 4 | 15.00% | 3.25% |

Although example data is disclosed above, any other suitable information may be included in the data indicative of at least one threshold associated with the aggregate credit rating quality limit. As an example, the data may not include information regarding the non-conformance factor. As a further example, each credit rating may have its own group.

Second, a credit rating of each of a second subset of assets in at least the portion of assets 42 is determined. For example, if assets 42 includes, for example, 500 single issuer assets, those 500 single issuer assets may be determined to be the second subset of the assets 42. Furthermore, for each of the entities that issued one of the single issuer assets, the credit rating may be determined. In such an example, if General Electric issued 400 of the single issuer assets in assets 42 and Goldman Sachs issued 100 of the single issuer assets in assets 42, the credit rating of General Electric is determined (which may be, as an example, AAA) and the credit rating of Goldman Sachs is determined (which may be, as an example, AAA). These determinations regarding the second subset and the credit rating may be determined by calculation device 114 based on the data indicative of a plurality of assets 42. For example, such data may indicate which of the assets 42 are single issuer assets, may further indicate which entity issued each single issuer asset, and may further indicated what the credit rating of each entity is.

Third, for a group of one or more of the credit ratings (such as AAA, AA+, AA, and AA− in group 1), a value associated with a number of assets in the second subset that have the one or more credit ratings is determined. For example, if 300 of the second subset of assets 42 have a credit rating of AAA, AA+, AA, and AA−, and the value of those 300 assets make up 11% of assets 42, the value associated with the number of assets in the second subset may be determined to be 11%. Furthermore, the value of 11% may be the characteristic value.

Fourth, for the group of one or more of the credit ratings (such as AAA, AA+, AA, and AA− in group 1), a value associated with the one or more credit ratings is determined. For example, if the data indicative of at least one threshold associated with the aggregate credit rating quality limit indicates that group 1 (with a credit rating of AAA, AA+, AA, and AA−) may issue 10% of the assets 42, the value associated with group 1 may be 10%. Furthermore, the value of 10% may be the threshold.

Fifth, the value associated with the number of assets in the second subset that have the one or more credit ratings is compared with the value associated with the one or more credit ratings. For example, the 11% characteristic value of group 1 may be compared with the 10% threshold of group 1 in order to determine that the characteristic value is above the threshold.

Sixth, the non-conformance amount associated with the aggregate credit rating quality limit is determined. For example, if the characteristic value is 10% and the threshold is 11%, a non-conformance factor (such as, for example, 0.5%) may be applied to the 1% of the characteristic value that is above the threshold. In such an example, the non-conformance amount for the group 1 single issuer assets may be $500,000 ($10 billion*1%*0.5%=$500,000).

Additionally, the non-conformance amount may further include the non-conformance amounts associated with the single issuer assets of the other groups (if any). For example, the non-conformance amount may include the total non-conformance amount for each of group 1, group 2, group 3, etc. Furthermore, this determined non-conformance amount may be utilized for the aggregate credit rating quality limit characteristic when the method of FIG. 5 moves to step 445 (disclosed above).

As a third example, when the characteristic is an asset class limit, steps 425-435 of FIG. 5 may be performed in a manner that may be different from (or the same as) that disclosed above. An asset class limit may represent a limit on the number of assets in assets 42 that are of a particular class. Furthermore, a class of an asset may represent any suitable classification for an asset, such as corporate, common stock, hedge fund, real estate, private equity, cash/agency/treasury, or any other classification of an asset. As such, the asset class limit may indicate that only 3% of the assets in assets 42 may be private equity assets. An example of the performance of steps 425-435 of FIG. 5 when the characteristic is an asset class limit is disclosed below.

First, data indicative of at least one threshold associated with an asset class limit is received. Such data may include information for any suitable threshold (or thresholds) associated with an asset class limit. As an example, the data may include information that identifies an asset class (e.g., private equity), a threshold amount associated with that asset class (e.g., 3%), a non-conformance factor for exceeding that threshold for that asset class (e.g., 3.5%), any other information, or any combination of the preceding. Furthermore, the data may include such information for any suitable number of asset classes. An example of this data is disclosed below:

| | | Non-conformance |
|---|---|---|
| Asset Class | Threshold | Factor |
| Corporate | NA | 0% |
| Common Stock | 0% | 0% |
| Hedge Funds | 0% | 0% |
| Real Estate | 0% | 0% |
| Alternatives - Private Equity | 3.00% | 3.50% |
| Tax Exempt Municipals | 0.00% | 3.5% |
| Non-Agency RMBS | 0.00% | 8.00% |
| (Residential Mortgage- | | |
| Backed Security) | | |
| Other Asset-Backed | 1.00% | 2.00% |
| Securities | | |
| CMBS (Commercial | 1.00% | 2.0% |
| Mortgage-Backed Security) | | |
| Non-Dollar Securities | 1.00% | 1.70% |
| Agency MBS/CMOs | 6.00% | 1.00% |
| (Mortgage-Backed Security/ | | |
| Collateralized Mortgage | | |
| Obligation) | | |
| Cash/Agencies/Treasuries | $100,000,000 | 1.50% |

Although example data is disclosed above, any other suitable information may be included in the data indicative of at least one threshold associated with an asset class limit. As an example, the data may not include information regarding the non-conformance factor.

Second, an asset class for each of a third subset of assets of at least a portion of assets 42 is determined. For example, if all of the assets 42 are included in one of the asset classes, all of assets 42 may be determined to be the third subset of the assets 42. Furthermore, for each of the assets in the third subset, an asset class is determined. In such an example, if the third subset includes corporate assets, private equity assets, real estate assets, and cash/agency/treasury assets, these particular asset classes are determined. These determinations regarding the third subset and each asset class in the third subset may be determined by calculation device 114 based on the data indicative of a plurality of assets 42. For example, such data may indicate which of the assets 42 are included in one of the asset classes, and may further indicate which asset class each asset is in.

Third, for one of the asset classes (e.g., private equity), a value associated with a number of assets in the third subset that have the asset class is determined. For example, if the assets in the private equity asset class make up 3.5% of the assets 42, the value associated with the number of assets in a third subset that have the private equity asset class may be determined to be 3.5%. Furthermore, the value of 3.5% may be the characteristic value.

Fourth, for one of the asset classes (e.g., private equity), a value associated with the asset class is determined. For example, if the data indicative of at least one threshold associated with the private equity asset class indicates that private equity assets may make up 3% of the assets 42, the value associated with the private equity asset class may be 3%. Furthermore, the value of 3% may be the threshold.

Fifth, the value associated with the number of assets in the third subset that have the asset class is compared with the value associated with the asset class. For example, the 3.5% characteristic value may be compared with the 3% threshold in order to determine that the characteristic value is above the threshold.

Sixth, the non-conformance amount associated with the asset class is determined. For example, if the characteristic value is 3.5% and the threshold is 3%, a non-conformance factor (such as, for example, 3.5%) may be applied to the 0.5% of the characteristic value that is above the threshold. In such an example, the non-conformance amount for the private equity asset class may be $1.75 million ($10 billion*0.5%*3.5%=$1.75 million). Additionally, the non-conformance amount may further include the non-conformance amounts associated with the other asset classes (if any). For example, the non-conformance amount may include the total non-conformance amount for each of the private equity asset class, the corporate asset class, the real estate asset class, the cash/agency/treasury asset class, and any other asset class. Furthermore, this determined non-conformance amount may be utilized for the asset class limit characteristic when the method of FIG. 5 moves to step 445 (disclosed above).

As a fourth example, when the characteristic is a reinvestment asset limit, steps 425-435 of FIG. 5 may be performed in a manner that may be different from (or the same as) that disclosed above. A reinvestment asset limit may represent a limit on the number of reinvestment assets that may be included in assets 42. Furthermore, a reinvestment asset may represent an asset that may need to be reinvested by issuer 18 because it is currently not invested (or is invested in undesirable investments). An example of a reinvestment asset may include a liquid asset, such as cash and/or any other type of asset that may be converted into cash quickly and with minimal impact to the price received. Pension plan 22 and issuer 18 may define what assets may be considered to be reinvestment assets when the agreement is signed at the first time point 64. Because it may take time and resources of issuer 18 to reinvest such a reinvestment asset, issuer 18 may set a limit on the number of reinvestment assets issuer 18 may be willing to accept as payment of premium 46. For example, the reinvestment asset limit may indicate that only $500 million in reinvestment assets may be included in assets 42 (or that assets 42 may only include 5% reinvestment assets). An example of the performance of steps 425-435 of FIG. 5 when the characteristic is a reinvestment asset limit is disclosed below.

First, data indicative of at least one threshold associated with the reinvestment asset limit is received. Such data may include information for any suitable threshold (or thresholds) associated with a reinvestment asset limit. As an example, the data may include information that identifies a threshold amount associated with the reinvestment asset (e.g., $1 billion), a non-conformance factor for exceeding that threshold (e.g., 0.15%), any other information, or any combination of the preceding. An example of this data is disclosed below:

| | Non- |
|---|---|
| | conformance |
| Threshold | Factor |
| $1 billion | 0.15% |
| $2 billion | 0.25% |
| $3 billion | 0.50% |
| $4 billion | 0.75% |
| $5 billion | 1.00% |
| $6 billion | 1.20% |
| $7 billion | 1.40% |
| $8 billion | 1.6% |
| $9 billion | 1.80% |
| $10 billion | 2.00% |

Although example data is disclosed above, any other suitable information may be included in the data indicative of at least one threshold associated with the reinvestment asset limit. As an example, the data may not include information regarding the non-conformance factor.

Second, a fourth subset of at least a portion of the assets 42 that comprises reinvestment assets is determined. In such an example, it may be determined which of the assets 42 are reinvestment assets and which of the assets 42 are not. The fourth subset may represent the assets that are reinvestment assets. This determination regarding the fourth subset may be determined by calculation device 114 based on the data indicative of a plurality of assets 42. For example, such data may indicate which of the assets 42 are reinvestment assets.

Third, a value associated with a number of assets in the fourth subset is determined. For example, if the fourth subset includes $1.1 billion in reinvestment assets, the value associated with a number of assets in the fourth subset may be determined to be $1.1 billion. Furthermore, the value of $1.1 billion may be the characteristic value.

Fourth, a value associated with a maximum number of reinvestment assets is determined. For example, if the data indicative of at least one threshold associated with the reinvestment asset limit indicates that assets 42 may only include $1 billion in reinvestment assets, the value associated with a maximum number of reinvestment assets may be $1 billion. Furthermore, the value of $1 billion may be the threshold.

Fifth, the value associated with the number of assets in the fourth subset is compared with the value associated with the maximum number of reinvestment assets. For example, the $1.1 billion characteristic value may be compared to the $1 billion threshold in order to determine that that characteristic value is above the threshold. As another example, the $1.1 billion characteristic value may be compared to the $2 billion second threshold in order to determine that that characteristic value is below the second threshold.

Sixth, the non-conformance amount associated with the reinvestment asset limit is determined. For example, if the characteristic value is $1.1 billion and the threshold is $1 billion, a non-conformance factor (such as, for example, 0.15%) may be applied to the $100 million of the characteristic value that is above the threshold. In such an example, the non-conformance amount for the reinvestment asset limit may be $150,000 ($100 million*0.15%=$150,000). As a further example, if the characteristic value is $2.1 billion, the first threshold is $1 billion (with a first non-conformance factor of 0.15%), and the second threshold is $2 billion (with a second non-conformance factor of 0.25%), the first non-conformance factor may be applied to the $1 billion of the characteristic value that is above the first threshold (and not above the second threshold), and the second non-conformance factor may be applied to the $100 million of the characteristic value that is above the second threshold. In such an example, the non-conformance amount for the reinvestment asset limit may be $3.25 million (($2 billion*0.15%)+($100 million*0.25%)=$3.25 million)). Furthermore, this determined non-conformance amount may be utilized for the reinvestment asset limit characteristic when the method of FIG. 5 moves to step 445 (disclosed above).

As a fifth example, when the characteristic is a key rate duration, steps 425-435 of FIG. 5 may be performed in a manner that may be different from (or the same as) that disclosed above. Key rate duration may represent an asset's (or a portfolio's) price sensitivity to interest rate shifts at selected key points along a yield curve. Key rate durations of the assets 42 may be compared to the key rate durations of the cash flows that the issuer 18 has determined would be desirable in order to pay for benefits 38 of the annuity 30 as they come due. In particular, based on the liability associated with the annuity 30, issuer 18 may have created a reference portfolio that has key rate durations that will provide a cash flow sufficient to satisfy the cash flow needed for benefits 38 in annuity 30. As an example, based on the liability (e.g., actual liability, as is discussed above) of annuity 30, the reference portfolio may have a key rate duration of 2.5 years at the 30 year maturity point. In order to determine whether the assets 42 provided by pension plan 22 will provide sufficient cash flow to pay for benefits 38 in annuity 30 as they come due, issuer 18 may compare the key rate duration of the assets 42 at, for example, the 30 year maturity point to the key rate duration of the reference portfolio at the 30 year point. If the assets 42 do not have a key rate duration at the 30 year point of, for example, 2.5 years, issuer 18 may adjust the premium amount to compensate for the difference.

An example of the performance of steps 425-435 of FIG. 5 when the characteristic is a key rate duration is disclosed below. First, data indicative of at least one threshold associated with the key rate duration may be determined. For example, if the reference portfolio created by issuer 18 has a key rate duration of 2.5 years at the 30 year point, the data may include any information that indicates this key rate duration of 2.5 years at the 30 year point. As another example, the data may include any information that would allow calculation device 114 to calculate the key rate duration of 2.5 years at the 30 year point. In such an example, the data may include information about one or more assets included in the reference portfolio. In particular, the key rate duration of the reference portfolio may be calculated by calculating the exposure of the assets in the reference portfolio at different maturity points and at different interest rates.

Second, a key rate duration of at least the portion of the assets 42 is determined. The portion of the assets may represent any portion of the assets 42 that are included in a calculation of key rate duration. For example, particular assets, such as cash, may not be included in the assets that are used to calculate key rate duration. The key rate duration of the portion of the assets 42 may be determined in any suitable manner. For example, the key rate duration of the portion of the assets 42 may be received at calculation device 114 based on an input from a user and/or administrator. As another example, the key rate duration of the portion of the assets 42 may be calculated by calculation device 114. In such an example, the calculation device 114 may receive data indicative of the assets 42, and based on such information, may calculate the key rate duration. In particular, the key rate duration may be calculated by calculating the exposure of the portion of the assets 42 at different maturity points and at different interest rates. If the portion of the assets 42 has a key rate duration of, for example, 3 years at the 30 year point, the key rate duration of the portion of the assets 42 may be determined to be 3 years at the 30 year point. Furthermore, this key rate duration of 3 years at the 30 year point may be the characteristic value.

Third, the key rate duration of a liability associated with the annuity 30 is determined. For example, if the data indicative of at least one threshold associated with the key rate duration indicates a key rate duration of 2.5 years at the 30 year point, the key rate duration of the liability associated with the annuity 30 may be 2.5 years at the 30 year point. Furthermore, this key rate duration of 2.5 years at the 30 year point may be the threshold.

Fourth, the key rate duration of at least a portion of the assets may be compared with the key rate duration of the liability associated with the annuity. For example, the characteristic value of 3 years at the 30 year point may be compared with the threshold of 2.5 years at the 30 year point in order to determine that the characteristic value is above the threshold.

Fifth, the non-conformance amount associated with the key rate duration is determined. For example, if the characteristic value is 3 years at the 30 year point and the threshold is 2.5 years at the 30 year point, a non-conformance factor (such as, for example, 20%) may be applied to the 0.5 of the characteristic value that is above the threshold. In such an example, the non-conformance amount for the key rate duration may be $1 billion ($10 billion*0.5*20%=$1 billion). As another example, if the characteristic value is 2 years at the 30 year point and the threshold is 2.5 years at the year point, a non-conformance factor (such as, for example, 20%) may be applied to the 0.5 of the characteristic value that is below the threshold. In such an example, the non-conformance amount for the key duration limit may be $1 billion ($10 billion*0.50*20%=$1 billion). Furthermore, this determined non-conformance amount may be utilized for the key rate duration characteristic when the method of FIG. 5 moves to step 445 (disclosed above).

In addition to the example characteristics disclosed above, characteristics may further include country limits, sector limits, technical breach adjustments, or any other suitable characteristics. For example, the county limits characteristic may represent a limit on assets 42 issued by particular countries. In such an example, countries may be grouped by whether the country is investment-grade (IG) or below-investment-grade (BIG). Furthermore, the country limits characteristic may have a threshold that indicates that assets issued by all IG countries cannot make up more than a first percentage (e.g., 10%) of assets 42 and that assets issued by all BIG countries cannot make up more than a second percentage (e.g., 2%) of assets 42. Additionally, the country limits characteristic may also have a threshold that indicates that assets issued by a single IG country (e.g., Albania) cannot make up more than a third percentage (e.g., 3%) of assets 42 and that assets issued by a single BIG country (e.g., Aruba) cannot make up more than a fourth percentage (e.g., 1.5%) of assets 42. Furthermore, the country limits characteristic may only apply to foreign countries, in one example.

As another example, the sector limits characteristic may represent a limit on assets 42 having a particular sector type (e.g., industrial, finance, utility, non-corporate, etc.). In such an example, the sector limits characteristic may have a threshold that indicates that industrial assets cannot make up more than a first percentage (e.g., 80%) of assets 42, that financial assets cannot make up more than a second percentage (e.g., 15%) of assets 42, that utility assets cannot make up more than a third percentage (e.g., 12%) of assets 42, and that non-corporate assets cannot make up more than a fourth percentage (e.g., 10%) of assets 42.

As a further example, technical breach adjustment characteristic may represent an adjustment for assets 42 that may breach one or more firm thresholds. A firm threshold may represent any threshold (such as any of the thresholds disclosed above) whose breach (e.g., above a maximum firm threshold, below a minimum firm threshold, or not being equal to a firm target) may result in the annuity generation 26 not occurring. For example, the hard threshold for asset class limit may be 3% of private equity. If the percentage of private equity assets that make up assets 42 is above or below that 3% hard threshold, issuer 18 may have the option to not go forward with the annuity generation 26. However, when such a breach occurs, pension plan 22 may utilize a technical breach adjustment (which may further increase the premium amount) in order to cause the annuity generation 26 to still occur. Such a technical breach adjustment may provide for any percentage or numerical adjustment of the premium amount. Furthermore, the technical breach adjustment may allow for any suitable amount of breach. For example, if the assets 42 provided by pension plan 22 only breach the firm thresholds by 1% individually and/or in total, a non-conformance factor of 1.5% may be applied to that additional 1% in order to determine a non-conformance amount associated with the technical breach adjustment characteristic. Furthermore, if the firm thresholds are breached by more than 1% individually and/or in total, it may be determined that the breach cannot be cured by the technical breach adjustment, and the annuity generation 26 may not Occur.

Modifications, additions, or omissions may be made to method 400. Additionally, one or more steps in method 400 of FIG. 5 may be performed in parallel or in any suitable order. For example, one or more (or each of) steps 425-435 of FIG. 5 may be performed for two or more (or each) of the characteristics in parallel.

As is disclosed above, the annuity generation 26 may cause the risk for one or more benefits 38 of pension plan 22 to be transferred from pension plan 22 to issuer 18. As such, issuer 18 may be liable to pay for the one or more benefits 38 going forward. Prior to the annuity generation 26 occurring, one or more administrators, boards, committees, and/or fiduciaries of pension plan 22 (and/or organization 14, and/or one or more participants of pension plan 22) may desire to receive assurances for how the payment of benefits 38 will be guaranteed by issuer 18. In particular, the administrators, boards, committees, and/or fiduciaries of pension plan 22 (and/or organization 14, and/or one or more participants of pension plan 22) may desire that the assets 42 included in the payment of premium 46 be allocated to a separate account that provides an insulated guarantee of the liability associated with benefits 38. This insulated guarantee may guarantee that the assets 42 in the separate account may only be used in association with benefits 38 (such as to pay for benefits 38 of annuity 30, pay for management of annuity 30, etc). As such, if issuer 18 begins to have trouble paying for its other liabilities (such as liabilities associated with other annuities provided by issuer 18), the assets 42 in the separate account cannot be used (or taken by a governmental agency, such as a bankruptcy court) to satisfy those other liabilities. Unfortunately, this desire to allocate all of assets 42 in a separate account of the issuer 18 may have problems. For example, some of the assets 42 may be of a type of asset that may be undesirable (or even unable) to be allocated to the separate account. As an example, certain types of assets 42 may be associated with a high level of risk that may impose burdens on issuer 18 (e.g., additional capital may be required to offset the high risk) and pension plan 22 (e.g., an increased premium amount may be required to offset the additional capital). In such an example, it may be desirable to allocate these high risk assets to a general account that provides an uninsulated guarantee.

FIG. 6 illustrates a method 500 for calculating an amount of a premium amount for allocation to a general account, and for further calculating an amount of the premium amount for allocation to a separate account according to one embodiment of the present disclosure. One or more steps of method 500 may be performed by calculation device 114 of FIG. 2. Furthermore, one or more steps of method 500 may be performed after, before, or in parallel with one or more steps of method 200 of FIG. 3, method 300 of FIG. 4, method 400 of FIG. 5, any other method, or any combination of the preceding.

The method begins at step 505. At step 510, a premium amount associated with a generation of an annuity 30 based on a pension plan 22 is determined. The premium amount may be any suitable amount associated with the generation of the annuity 30 based on the pension plan 22. For example, the premium amount may be the same amount as the first total premium amount determined in step 235 of method 200 of FIG. 3. In such an example, after the first total premium amount is determined at step 235 of method 200 of FIG. 3, the first total premium amount may be utilized as the premium amount for step 510 of method 500 of FIG. 6. By utilizing the first total premium amount from FIG. 3 (which may be the preliminary premium amount disclosed above with regard to FIGS. 1A-1B), pension plan 22 and issuer 18 may both be able to understand how the final premium may be allocated between the separate account and the general account, even though one or more variables regarding the annuity generation 26 may be unknown at the time. As another example, the premium amount may be the same amount as the second total premium amount determined in step 250 of method 200 of FIG. 3. In such an example, after the second total premium amount is determined at step 250 of method 200 of FIG. 2, the second total premium amount may be utilized as the premium amount for step 510 of method 500 of FIG. 6. By utilizing the second total premium amount from FIG. 3 (which may be the final premium amount disclosed above with regard to FIGS. 1A-1B), pension plan 22 and issuer 18 may be able to understand how that final premium actually will be allocated between the separate account and the general account. As another example, the premium amount may include any of the adjusted premium amounts from FIGS. 4-5. By utilizing the adjusted premium amounts from FIG. 4 and/or FIG. 5, pension plan 22 and issuer 18 may be able to understand how the adjusted premiums amounts actually will (or may) be allocated between the separate account and the general account.

At step 515, a first portion of the premium amount is determined. The first portion of the premium amount may represent a portion of the premium amount that is eligible for allocation to the separate account of issuer 18. Although the first portion of the premium amount may be eligible for allocation to the separate account, the entire first portion of the premium amount may not actually be allocated to the separate account. For example, the first portion of the premium amount may be $9 billion, but only $8.5 billion of that first portion may eventually be actually allocated to the separate account.

The first portion of the premium amount may be any suitable amount that is eligible for allocation to the separate account. For example, the first portion of the premium amount may be the entire premium amount, or only a portion of the premium amount. As another example, the first portion of the premium amount may be an amount of the premium amount that may be required to be allocated to the separate account in order for the separate account to provide an insulated guarantee of the entire liability (e.g., the entire actual liability, as is discussed above) associated with the annuity 30. In particular, annuity generation 26 may give rise to a statutory reserve (e.g., by one or more governmental agencies, rules, and/or laws) for a separate account for an annuity 30. Such a statutory reserve may require that a particular amount of assets 42 be allocated (e.g., 100% of the statutory reserve) to the separate account in order for the separate account to provide an insulated guarantee for the liability associated with the annuity 30. As such, if the liability associated with the annuity generation 26 is $9 billion, the statutory reserve may require that $9 billion (e.g., 100% of the liability) in assets 42 be allocated to the separate account in order for the separate account to provide an insulated guarantee of the entire $9 billion liability associated with the annuity 30. On the other hand, if the entire liability associated with the annuity generation 26 is $9 billion, and only $8 billion in assets 42 is allocated to the separate account, the statutory reserve may provide that separate account may only provide an insulated guarantee for $8 billion of the $9 billion liability associated with the annuity 30. As a result, the other $1 billion of the liability associated with the annuity 30 may only be guaranteed by the general account.

The separate account may represent any account of issuer 18 that provides an insulated guarantee (or other form of credit enhancement). By providing an insulated guarantee, the assets in the separate account, can only be used in association with benefits (such as to pay for benefits of the annuity, pay for management of the annuity, etc) designated by the separate account (such as benefits 38 of annuity 30). For example, pursuant to various rules, laws (e.g., state insurance laws), and contract provisions, the assets in the separate account may not be chargeable with liabilities arising out of any other business that issuer 18 may conduct (e.g., liabilities associated with other annuities). On the other hand, the general account may represent any other account of the issuer 18 that does not provide an insulated guarantee. Because an insulated guarantee is not provided by the general account, any of the assets in the general account may be used (subject to one or more rules, laws, and contract provisions) in association with any of the liabilities of issuer 18 (such as in association with benefits of annuities other than annuity 30).

The first portion of the premium amount may be determined in any suitable manner. For example, the first portion of the premium amount may be received at calculation device 114 based on an input from a user and/or administrator. In such an example, the user may review information associated with each participant 34 and benefit 38 of annuity 30, may determine the first portion of the premium amount, and may input the first portion into calculation device 114. As another example, the first portion of the premium amount may be calculated by calculation device 114. In such an example, the calculation device 114 may receive data indicative of the plurality of participants 34 in the pension plan 22, and based on such information, may calculate the first portion of the premium amount. In particular, the calculation device 114 may calculate the first portion of the premium amount using a calculation for a statutory reserve.

At step 520, a second portion of the premium amount is determined. The second portion of the premium amount may include any amount of the premium amount for allocation to a general account. In particular, the second portion of the premium may include an amount that will be allocated to the general account in order to prevent one or more burdens from being imposed on issuer 18 (e.g., additional capital may be required to offset the high risk) and pension plan 22 (e.g., an increased premium amount may be required to offset the additional capital). The second portion of the premium amount may be any suitable amount of the premium amount. As an example, the second portion of the premium amount may represent an amount of the premium amount that will be paid to issuer 18 using particular assets 42. In such an example, the particular assets 42 may be high risk assets. Such high risk assets may be any high risk asset or may only be a particular type of high risk assets (e.g., private equity assets).

A high risk asset may represent any investment that includes a high level of risk, such as a private equity asset, a high yield bond, unstable currency, any investment determined by one or more rules or laws (e.g., state insurance laws) to not be applicable towards a statutory reserve, or any other high risk asset. As an example, a high risk asset may be a private equity asset. A private equity asset may represent an investment that is not quoted on a public exchange (such as the New York Stock Exchange). For example, a private equity asset may include an investment made directly into a private company and/or an investment into a buyout of a public company that results in a delisting of public equity. High risk assets may further include one or more promissory notes associated with a high risk asset. For example, particular high risk assets (e.g., private equity) may traditionally only be purchased at the end of a fiscal quarter. However, a promissory note for the high risk asset may be signed before the end of the quarter, and may require that portion of the high risk asset to be sold to issuer 18 when the quarter finally ends.

The second portion of the premium amount may be determined in any suitable manner. For example, the second portion of the premium amount may be received at calculation device 114 based on an input from a user and/or administrator. In such an example, the user may determine the second portion of the premium amount (e.g., the user may have been told by pension plan 22 the amount of high risk assets that will be included in the payment of premium 46, the user may have calculated the amount of high risk assets that will be included in the payment of premium 46, etc.) and input the second portion of the premium amount into calculation device 114. As another example, the second portion of the premium may be calculated by calculation device 114. The calculation device 114 may calculate the second portion in any suitable manner. As a first example, calculation device 114 may multiply the premium amount (e.g., $10 billion premium) by a percentage of the assets 42 that are high risk assets (e.g., 4.5%) in order to calculate the second portion. In such an example, if pension plan 22 and issuer 18 agreed that high risk assets included in the payment of premium 46 would include 4.5% of the $10 billion premium amount, calculation device 114 may calculate that the second portion is $450 million ($10 billion*4.5%=$450 million). Additionally, another example of the calculation of the second portion may include the following steps:

First, data indicative of a plurality of assets 42 to be used towards the payment of the premium amount may be received. The data indicative of the plurality of assets 42 may include any type of information associated with the assets 42. For example, the data may include an identifier of each of the assets (such as the name of the asset or an identification number associated with the asset), one or more ratings of each asset (such as AAA, AA+, AA, AA−, A+, A, A−, BBB+, BBB, etc.), an identifier of each type of asset, a number of each asset (such as 1 share of a particular stock, 2 shares of a particular stock, etc.), a current value of each asset, any other suitable information, or any combination of the preceding. The data indicative of the plurality of assets 42 may be received in any suitable manner. As an example, the data may be manually input into calculation device 114 of FIG. 2 by a user or an administrator. As another example, the data may be downloaded (or otherwise communicated) from a data source 158 of FIG. 2 (such as Moody's Investors Service, Barclays Investment Bank, Standard & Poor's, organization 14, pension plan 22, etc.).

Second, a subset of the plurality of assets 42 is determined. The subset of the plurality of assets 42 may include any suitable number of assets in the plurality of assets 42. For example, the subset may include each asset in assets 42 that is a high risk asset. Furthermore, the subset of the plurality of assets 42 may be determined in any suitable manner. For example, calculation device 114 may utilize the data indicative of the plurality of assets to identify which of the assets in assets 42 are high risk assets.

Third, an amount associated with the subset is calculated. The amount associated with the subset may be calculated in any suitable manner. For example, calculation device 114 may sum the market value of each asset in the subset (e.g., each of the high risk assets). In such an example, if the subset includes 15 high risk assets, and each of those high risk assets has a current market value of $300, the amount associated with the subset may be calculated to be $4,500 (15*$300=$4,500). Once the amount associated with the subset is calculated, calculation device 114 may utilize the calculated amount associated with the subset as the second portion of the premium amount.

At step 525, a third portion of the premium amount is calculated. The third portion of the premium amount may represent a portion of the premium amount that is eligible for allocation to the general account of issuer 18. Although the third portion of the premium amount may be eligible for allocation to the general account, the entire third portion of the premium amount may not actually be allocated to the general account. For example, the third portion of the premium amount may be $1 billion, but only $500 million of that first portion may eventually actually be allocated to the general account. The third portion of the premium amount may include any amount of the premium amount that is eligible for allocation to the general account. For example, the third portion of the premium amount may include the amount of the premium amount that is not in the first portion of the premium amount. In such an example, if the premium amount is $10 billion, and the first portion of the premium amount eligible for allocation to the separate account is $9 billion, the third portion of the premium amount may be $1 billion ($10 billion−$9 billion=$1 billion). In such an example, the third portion of the premium amount may represent an amount of the premium amount that may be allocated to the general account of issuer 18 while still allowing the separate account to provide an insulated guarantee of the entire liability associated with the annuity 30. For example, if the statutory reserve provides that a separate account may provide a guarantee for an entire liability of $9 billion if $9 billion (e.g., 100% of the liability) in assets 42 is allocated to the separate account, the third portion of the premium amount may represent the $1 billion of the premium amount that does not need to be allocated to the separate account in order to guarantee the entire liability of $9 billion. The third portion of the premium amount may be calculated in any suitable manner. For example, the third portion of the premium amount may be calculated based the premium amount and the first portion of the premium amount, as is disclosed above.

At step 530, a subset of the first portion of the premium amount is calculated. The subset of the first portion of the premium amount may represent an amount that is to be removed from the first portion of the premium amount. For example, as is disclosed above, the first portion of the premium amount may be an amount of the premium amount that is eligible for allocation to a separate account. Unfortunately, in order to compensate for high risk assets (e.g., private equity assets), some of the first portion of the premium amount (i.e., the subset) may not actually be allocated to the separate account. Instead, the subset of the first portion may be allocated to the general account in order to compensate for the high risk assets. The subset of the first portion may include any amount that may be removed from the first portion in order to compensate for the high risk assets. For example, the subset of the first portion may be zero (resulting in nothing being removed from the first portion). As another example, the subset of the first portion may be an amount greater than zero (resulting in at least some amount being removed from the first portion).

The subset of the first portion of the premium amount may be calculated in any suitable manner. For example, the subset of the first portion of the premium amount may be calculated based on the second and third portions of the premium amount. In such an example, if the second portion of the premium amount (e.g., the amount of high risk assets) is less than the third portion of the premium amount (e.g., a portion of the premium amount that is eligible for allocation to the general account of issuer 18), the subset of the first portion of the premium amount may be calculated to be zero. For example, if the second portion is $450 million and the third portion is $1 billion, the subset may be calculated to be zero. As such, nothing may be removed from the first portion of the premium amount, resulting in the entire first portion of the premium amount being allocated to the separate account. On the other hand, if the second portion is greater than the third portion of the premium amount, the subset of the first portion of the premium amount may be calculated to be the difference between the second portion of the premium amount and the third portion of the premium amount. For example, if the second portion of the premium amount is $1 billion, but the third portion of the premium amount is only $500 million, the subset of the first portion of the premium amount may be calculated to be $500 million ($1 billion−$500 million=$500 million). As such, if the first portion of the premium amount eligible for allocation to the separate account is $9 billion, the $500 million subset may be removed from that amount, resulting in $8.5 billion being allocated to the separate account. Furthermore, the removed $500 million (i.e., the subset) may be allocated to the general account.

Additionally, based on, for example, the statutory reserve, the removal of a positive amount (e.g., any amount over zero) from the first portion of the premium amount may cause the separate account to not be able to provide an insulated guarantee for the entire liability associated with the annuity 30. For example, if the statutory reserve requires that $9 billion (e.g., 100% of the liability) in assets 42 be allocated to the separate account in order for the separate account to provide an insulated guarantee of the entire $9 billion liability associated with the annuity 30, but only $8.5 billion in assets 42 is allocated to the separate account, the separate account may only provide an insulated guarantee for $8.5 billion in liability (which is 94.44% of the liability associated with annuity 30). In such an example, the other 5.56% of the liability associated with annuity 30 (e.g., $500 million) may be guaranteed by the general account (not the separate account).

Furthermore, although the subset of the first portion of the premium amount has been disclosed above as a particular amount (e.g., an amount over zero), the subset may further include data that may be calculated based on the particular amount. For example, instead of the subset being represented as the $500 million amount being removed from the first portion of the premium amount, it may be represented as a percentage of the amount being removed from the first portion of the premium amount, such as 5.56%. As another example, the subset may also be represented as the amount of liability associated with annuity 30 that will not be guaranteed by the separate account (e.g., the $500 million (and/or the 5.56%) calculated above) as a result of the removal of the subset from the first portion of the premium amount).

At step 535, the subset of the first portion of the premium amount is communicated for display. As such, pension plan 22 and issuer 18 may be able to understand how much of the premium amount cannot be allocated to the separate account without imposing burdens on issuer 18 (e.g., additional capital may be required to offset the high risk) and pension plan 22 (e.g., an increased premium amount may be required to offset the additional capital). Once the subset of the first portion of the premium amount is communicated for display, the method may move to step 540, where the method ends.

Although FIG. 6 illustrates method 500 as ending at step 540, in particular embodiments, the method may not end. For example, instead of ending, method 500 may include additional steps where additional information is communicated for display. In such an example, the first portion of the premium amount may be communicated for display, the second portion of the premium amount may be communicated for display, the third portion of the premium amount may be communicated for display, any other amount associated with the premium amount may be communicated for display, or any combination of the preceding.

As another example, instead of ending, method 500 may include additional steps where additional information is calculated and then communicated for display. In such an example, method 500 may further include one or more steps where a fourth portion of the premium amount is calculated. The fourth portion of the premium amount may represent an amount of the premium amount that will be allocated to the separate account. The fourth portion of the premium amount may be calculated in any suitable manner. For example, the fourth portion of the premium amount may be calculated based on the first portion of the premium amount and the subset of the first portion of the premium amount. In such an example, if the first portion of the premium amount is $9 billion and the subset of the first portion of the premium amount is $500 million, the fourth portion of the premium amount may be calculated to be $8.5 billion ($9 billion−$500 million=$8.5 billion). Additionally, instead of the fourth portion being represented as the particular amount (e.g., $8.5 billion) being allocated to the separate account, the fourth portion may also be represented as the amount of liability associated with annuity 30 that will be guaranteed by the separate account (e.g., the $8.5 billion (and/or the 94.44% of the liability) calculated above) as a result of the fourth portion being allocated to the separate account.

Modifications, additions, or omissions may be made to method 500. Additionally, one or more steps in method 500 of FIG. 6 may be performed in parallel or in any suitable order.

Although the present disclosure has been described with several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. A system, comprising:
a memory;
one or more processors communicatively coupled to the memory and operable to:
receive data indicative of a plurality of participants in a pension plan;
prior to any of the plurality of participant electing to receive a liability payout associated with the pension plan:
for each of the plurality of participants:
determine data indicative of a first premium amount associated with a benefit of the pension plan that the participant is not eligible to elect to receive as the liability payout; and
determine data indicative of a second premium amount associated with a benefit of the pension plan that the participant is eligible to elect to receive as the liability payout;
determine a first total premium amount associated with a generation of an annuity based on the pension plan, the first total premium amount being based, at least in part, on the first premium amount for each of the plurality of participants and the second premium amount for each of the plurality of participants; and
communicate the first total premium amount for display;
receive data indicative of a determination that a subset of the plurality of participants elected to not receive the liability payout;
determine a second total premium amount associated with the generation of the annuity based on the pension plan, the second total premium amount being based, at least in part, on the first premium amount for each of the plurality of participants and the second premium amount for each of the subset of the plurality of participants; and
communicate the second total premium amount for display.

2. The system of claim 1, wherein
the second total premium amount is further based, at least in part, on a risk factor; and
the risk factor is based, at least in part, on a subset of the plurality of participants that elected to receive the liability payout.

3. The system of claim 2, wherein the risk factor is further based, at least in part, on a second subset of the plurality of participants that elected to change a benefit associated with the pension plan.

4. The system of claim 1, wherein the one or more processors are further operable to:
organize the plurality of participants into a plurality of groups of participants;
determine, for each of the groups of participants, a group premium amount based, at least in part, on:
the second premium amount for each of the plurality of participants that are both in the group and are also in the subset of the plurality of participants; and
a risk factor associated with the group, the risk factor being based, at least in part, on a number of the plurality of participants that are both in the group and also elected to receive the liability payout; and
determine the second total premium amount based, at least in part, on:
the first premium amount for each of the plurality of participants; and
each of the group premium amounts.

5. The system of claim 4, wherein the plurality of groups of participants comprise one of:
age groups of the plurality of participants; and
gender of the plurality of participants.

6. The system of claim 4, wherein the one or more processors are further operable to communicate each of the group premium amounts for display.

7. The system of claim 6, wherein the one or more processors are further operable to communicate for display:
for each of the groups of participants:
the second premium amount for each of the plurality of participants that are both in the group and are also in the subset of the plurality of participants; and
the risk factor associated with the group.

8. A non-transitory computer readable medium comprising logic, the logic, when executed by a processor, operable to:
receive data indicative of a plurality of participants in a pension plan;
prior to any of the plurality of participant electing to receive a liability payout associated with the pension plan:
for each of the plurality of participants:
determine data indicative of a first premium amount associated with a benefit of the pension plan that the participant is not eligible to elect to receive as the liability payout; and
determine data indicative of a second premium amount associated with a benefit of the pension plan that the participant is eligible to elect to receive as the liability payout;
determine a first total premium amount associated with a generation of an annuity based on the pension plan, the first total premium amount being based, at least in part, on the first premium amount for each of the plurality of participants and the second premium amount for each of the plurality of participants; and
communicate the first total premium amount for display;
receive data indicative of a determination that a subset of the plurality of participants elected to not receive the liability payout;
determine a second total premium amount associated with the generation of the annuity based on the pension plan, the second total premium amount being based, at least in part, on the first premium amount for each of the plurality of participants and the second premium amount for each of the subset of the plurality of participants; and
communicate the second total premium amount for display.

9. The computer readable medium of claim 8, wherein
the second total premium amount is further based, at least in part, on a risk factor; and
the risk factor is based, at least in part, on a subset of the plurality of participants that elected to receive the liability payout.

10. The computer readable medium of claim 9, wherein the risk factor is further based, at least in part, on a second subset of the plurality of participants that elected to change a benefit associated with the pension plan.

11. The computer readable medium of claim 8, wherein the logic, when executed by the processor, is further operable to:
organize the plurality of participants into a plurality of groups of participants;
determine, for each of the groups of participants, a group premium amount based, at least in part, on:
the second premium amount for each of the plurality of participants that are both in the group and are also in the subset of the plurality of participants; and
a risk factor associated with the group, the risk factor being based, at least in part, on a number of the plurality of participants that are both in the group and also elected to receive the liability payout; and
determine the second total premium amount based, at least in part, on:
the first premium amount for each of the plurality of participants; and
each of the group premium amounts.

12. The computer readable medium of claim 11, wherein the plurality of groups of participants comprise one of:
age groups of the plurality of participants; and
gender of the plurality of participants.

13. The computer readable medium of claim 11, wherein the logic, when executed by the processor, is further operable to communicate each of the group premium amounts for display.

14. A method, comprising:
receiving, by one or more processors, data indicative of a plurality of participants in a pension plan;
prior to any of the plurality of participant electing to receive a liability payout associated with the pension plan:
for each of the plurality of participants:
determining, by the one or more processors, data indicative of a first premium amount associated with a benefit of the pension plan that the participant is not eligible to elect to receive as the liability payout; and
determining, by the one or more processors, data indicative of a second premium amount associated with a benefit of the pension plan that the participant is eligible to elect to receive as the liability payout;
determining, by the one or more processors, a first total premium amount associated with a generation of an annuity based on the pension plan, the first total premium amount being based, at least in part, on the first premium amount for each of the plurality of participants and the second premium amount for each of the plurality of participants; and
communicating, by the one or more processors, the first total premium amount for display;
receiving, by the one or more processors, data indicative of a determination that a subset of the plurality of participants elected to not receive the liability payout;
determining, by the one or more processors, a second total premium amount associated with the generation of the annuity based on the pension plan, the second total premium amount being based, at least in part, on the first premium amount for each of the plurality of participants and the second premium amount for each of the subset of the plurality of participants; and
communicating, by the one or more processors, the second total premium amount for display.

15. The method of claim 14, wherein
the second total premium amount is further based, at least in part, on a risk factor; and
the risk factor is based, at least in part, on a subset of the plurality of participants that elected to receive the liability payout.

16. The method of claim 15, wherein the risk factor is further based, at least in part, on a second subset of the plurality of participants that elected to change a benefit associated with the pension plan.

17. The method of claim 14, further comprising organizing the plurality of participants into a plurality of groups of participants; and
wherein determining, by the one or more processors, the second total premium amount comprises:
determining, for each of the groups of participants, a group premium amount based, at least in part, on:
the second premium amount for each of the plurality of participants that are both in the group and are also in the subset of the plurality of participants; and
a risk factor associated with the group, the risk factor being based, at least in part, on a number of the plurality of participants that are both in the group and also elected to receive the liability payout; and
determining the second total premium amount based, at least in part, on:
the first premium amount for each of the plurality of participants; and
each of the group premium amounts.

18. The method of claim 17, wherein the plurality of groups of participants comprise one of:
age groups of the plurality of participants; and
gender of the plurality of participants.

19. The method of claim 17, further comprising communicating, by the one or more processors, each of the group premium amounts for display.

20. The method of claim 19, further comprising communicating, by the one or more processors, for display:
for each of the groups of participants:
the second premium amount for each of the plurality of participants that are both in the group and are also in the subset of the plurality of participants; and
the risk factor associated with the group.
